(19) United States
(12) Patent Application Publication
(10) Pub. No.: US 2016/0098636 A1
(43) Pub. Date: Apr. 7, 2016

(54) DATA PROCESSING APPARATUS, DATA PROCESSING METHOD, AND RECORDING MEDIUM THAT STORES COMPUTER PROGRAM

(71) Applicant: NEC Corporation, Tokyo (JP)

(72) Inventor: Takahiro OKONOGI, Tokyo (JP)

(73) Assignee: NEC Corporation, Tokyo (JP)

(21) Appl. No.: 14/861,603

(22) Filed: Sep. 22, 2015

(30) Foreign Application Priority Data
Oct. 6, 2014 (JP) 2014-205759

(51) Int. Cl. G06N 5/02; G06N 99/00

(52) U.S. Cl. CPC G06N 5/025; G06N 99/005

(57) ABSTRACT

Provided is a data processing apparatus creates teacher data used for learning of a machine learning system by classifying data extracted from time series data on the basis of a specific reference. The data processing apparatus includes a data extraction unit which extracts a candidate of teacher data, from time series data, a teacher data creation unit which creates the teacher data based on a label to classify the candidate of teacher data, and the candidate of teacher data which are labeled, and a teacher data complement unit which further extracts the candidate of the teacher data from the time series data that exists between a specific candidate of the teacher data at a specific timing and one of other candidates of the teacher data at a timing different from the specific timing, based on a degree of a variation between these candidates of the teacher data.

This application is based upon and claims the benefit of priority from Japanese Patent Application No. 2014-205759, filed on Oct. 6, 2014, the disclosure of which is incorporated herein in its entirety by reference.

### TECHNICAL FIELD

The present invention relates to creation of data for learning, or the like, in a data analysis system using machine learning.

### BACKGROUND ART

In recent years, the data analysis system using machine learning is widely used. As a technology used in such system, for example, a technology for extracting a scene that satisfies specific condition by analyzing moving picture (or, video) data with using a machine learning system, is known. As for another example, a technology for classifying scenes in the moving picture according to predetermined criteria, or the like is also known. In some case, it is required to prepare, in advance, a sufficient amount of data to be used for learning process of the machine learning system, in order to analyze data by such data analysis system.

For example, such data for learning is created by manually executing an extraction process or a classification process for data that is an analysis target. A learning process in the machine learning system is executed by using the data for learning, created by such method (hereinafter, the data may be called “teacher data”). And as a result of learning, model data (model) is created. The machine learning system analyzes newly provided data by referring to the model data.

For example, when the analysis target data is moving picture data, for example, there may be a case that a person classifies (labels) an image data that constitutes the moving picture data appropriately frame by frame, in order to prepare the teacher data. In this case, a user or the like (a user of a system, an engineer, an administrator, or the like) classifies the image data manually, based on a result of a visual observation of the image data. In this case, for example, the user or the like assigns the label to the image data constituting the moving picture data, while reproducing the moving picture data. This process requires many man-hours.

In such system, when a result of analysis using the created model is insufficient (in other words, when the analysis result with sufficient accuracy are not achieved), it may be difficult to determine the cause which brought the result. Specifically, the user or the like may not easily determine the cause, that an amount of the teacher data is insufficient, or analyzing a specific usage scene (specific analysis data) is fundamentally difficult, or the like. In order to investigate the cause, the user or the like has to execute a process of trial and error.

A technology relating to collection (or creation) of learning data mentioned above is disclosed in the following patent literatures. A technology for creating learning images used in development of image recognition software is disclosed in patent literature 1 (Japanese Patent Application Laid-Open No. 2011-145791). The technology disclosed in patent literature 1 is a method for extracting an area (partial image) of image in which a recognition object is recorded from an an original image (a moving picture or the like) input, and clustering the extracted partial images. The method of the technology disclosed in patent literature 1, creates the learning image by automatically or manually assigning identification information to each class, into which the result of clustering is classified. Further, the method of the technology disclosed in patent literature 1, creates a candidate of the learning image by extracting an image similar to a representative image input by a user.

A technology relating to a classifier, which detects a detection object in an image by using a plurality of detectors being learned by machine learning process, is disclosed in patent literature 2 (Japanese Patent Application Laid-Open No. 2012-190159). A method of the technology disclosed in patent literature 2 calculates an imaging area which is used as the candidate for a learning image, and a score, by integrating results of detection processes for input images, executed by the detectors. The method of the technology disclosed in patent literature 2, selects the learning image used for re-learning of the detector, among the candidate of the learning images, on the basis of the calculated score and a predetermined adoption rate.

A technology relating to a method for creating teacher data used for the machine learning procedure for a classifier, is disclosed in patent literature 3 (Japanese Patent Application Laid-Open No. 2013-025745). the creation method of the technology disclosed in patent literature 3 presents basic data (an image or the like) that is a base of the teacher data to a user, and obtains a first class assigned to the basic data by the user. The method of the technology disclosed in patent literature 3 presents a second class, which is created based on information about similarity, co-occurrence, or relatedness to the first class, to the user, and obtains an evaluation result by the user to the second class. The method of the technology disclosed in patent literature 3 creates teacher data by associating the second class to which the evaluation result of the user is reflected, the first class, and the basic data.

A technology relating to a method for extracting a still image from moving picture data is disclosed in patent literature 4 (Japanese Patent Application Laid-Open No. 2004-117622). The method of patent literature 4 appropriately extracts the still image from the moving picture according to speed of motion of a target object recorded in the moving picture. The method of technology disclosed in patent literature 4 calculates speed of the motion of the target object recorded in the moving picture and extracts the still image from the moving picture at a time interval according to the speed of the motion.

### SUMMARY

One of a main object of the present invention is to provide a data processing apparatus or the like, that is able to extract data which is base of the teacher data from time series data, according to a specific criterion, and to create the teacher data by classifying the extracted data.

In order to achieve the above-mentioned object, a data processing apparatus according to one aspect of the present invention has the following configuration. The data processing apparatus according to one aspect of the present invention includes a data extraction unit that is configured to extract a candidate of teacher data that is a part of data at a specific timing, from time series data; a teacher data creation unit that is configured to create teacher data on the basis of a label by which the candidate of teacher can be classified and the candidate of teacher data to which the label is assigned; and a teacher data complement unit that is configured to further extract the candidate of the teacher data from the time series data that exists between a specific candidate of the teacher data and one of other candidates of the teacher data on the basis of a degree of a variation between the specific candidate of the teacher data at a specific timing, and the one of other candidates of the teacher data at a timing different from the specific timing, in time series data, the candidate of the teacher data extracted by the teacher data complement unit being assigned with the label that is assigned to either the specific candidate of the teacher data or the one of other candidates of the teacher data and being appended to the teacher data, by the teacher data creation unit, when the degree of the variation is smaller than a first reference.

A data processing method according to another aspect of the present invention has the following configuration. The data processing method according to on another e aspect of the present invention, includes extracting a candidate of teacher data from time series data that exists between a specific candidate of the teacher data and one of other candidates of the teacher data on the basis of a degree of variation between the specific candidate of the teacher data and the one of other candidates of the teacher data, the specific candidate of the teacher data being a part of data at a specific timing in the time series data, and the one of other candidates of the teacher data being a part of data at a timing different from the specific timing in the time series data, assigning a label, by which the candidate of the teacher data can be classified, to the extracted candidate of the teacher data, when the degree of variation is smaller than a first reference, the label assigned to the extracted candidate of the teacher data being the label assigned to either the specific candidate of the teacher data or the one of other candidates of the teacher data, and creating the teacher data on the basis of the data to which the label is assigned.

Further, the object can also be achieved by a computer program, that allows a computer to realize the data processing apparatus configured as above and the corresponding data processing method, or by non-transitory computer readable recording medium that stores the computer program.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a functional configuration of a data processing apparatus according to a first exemplary embodiment of the present invention,

FIG. 2 is a figure illustrating an specific example of a setting information table according to each exemplary embodiment of the present invention,

FIG. 3 is a figure illustrating a specific example of a screen displaying a candidate of teacher data to a user or the like in each exemplary embodiment of the present invention,

FIG. 4A is a flowchart illustrating an example of a process for creating a still image group (a candidate of teacher data) in the first exemplary embodiment of the present invention,

FIG. 4B is a flowchart illustrating an example of a process for creating teacher data in the first exemplary embodiment of the present invention,

FIG. 5 is a block diagram illustrating an example of a functional configuration of a data processing apparatus according to a second exemplary embodiment of the present invention,

FIG. 6 is a flowchart illustrating an example of a process for creating a still image group (a candidate of teacher data) on the basis of a difference from a background image in the second exemplary embodiment of the present invention,

FIG. 7 is a block diagram illustrating an example of a functional configuration of a data processing apparatus according to a third exemplary embodiment of the present invention,

FIG. 8 is a flowchart illustrating an example of a process for creating model data in the third exemplary embodiment of the present invention,

FIG. 9 is a flowchart illustrating an example of a process for creating teacher data in the third exemplary embodiment of the invention of the present application,

FIG. 10 is a block diagram illustrating an example of a functional configuration of a data processing apparatus according to a fourth exemplary embodiment of the present invention,

FIG. 11 is a flowchart illustrating an example of a process for creating a still image group (a candidate of teacher data) in the fourth exemplary embodiment of the present invention,

FIG. 12 is a flowchart illustrating an example of a process for creating teacher data in the fourth exemplary embodiment of the present invention,

FIG. 13 is a block diagram illustrating an example of a functional configuration of a data processing apparatus according to a fifth exemplary embodiment of the present invention, and

FIG. 14 is a block diagram illustrating an example of a hardware configuration of an information processing apparatus which can realize each component of the data processing apparatus according to each exemplary embodiment of the present invention.

### EXEMPLARY EMBODIMENT

Next, an exemplary embodiment of the present invention will be described in detail with reference to the drawing. Hereinafter, data constituting a moving picture may be described as “moving picture data” or “moving picture”. The data constituting a moving picture also may be described as “video data”, or “video”. Data constituting a still image may be described as “still image data” or “still image”.

In each exemplary embodiment below, a case for creating teacher data that are used for the machine learning procedure in a moving picture analysis (a moving picture analysis system) using machine learning, is assumed as a specific example. In this case, a creation process of the teacher data includes a process for assigning a label for classifying still images, to each still image constituting the moving picture data, that is time series data. The label may be assigned on the basis of whether or not each still image satisfies a specific condition. In this case, each still image is classified on the basis of whether or not each still image satisfies the specific condition.

For example, this moving picture analysis system can be applied to a purpose of finding a scene that satisfies the specific condition in the moving picture data. Further, for example, the moving picture analysis system can be applied to a purpose of classifying the entire moving picture data on the basis of whether or not the data satisfies the specific condition.

A configuration described in the following exemplary embodiment is shown as an specific example. The technical scope of the present invention is not limited to the exemplary embodiment described below. That is, the technical scope of the present invention is not limited to the moving picture analysis exemplary described below, and the present invention can be applied to the analysis of arbitrary time series data such as a voice, various signal waves, or the like.

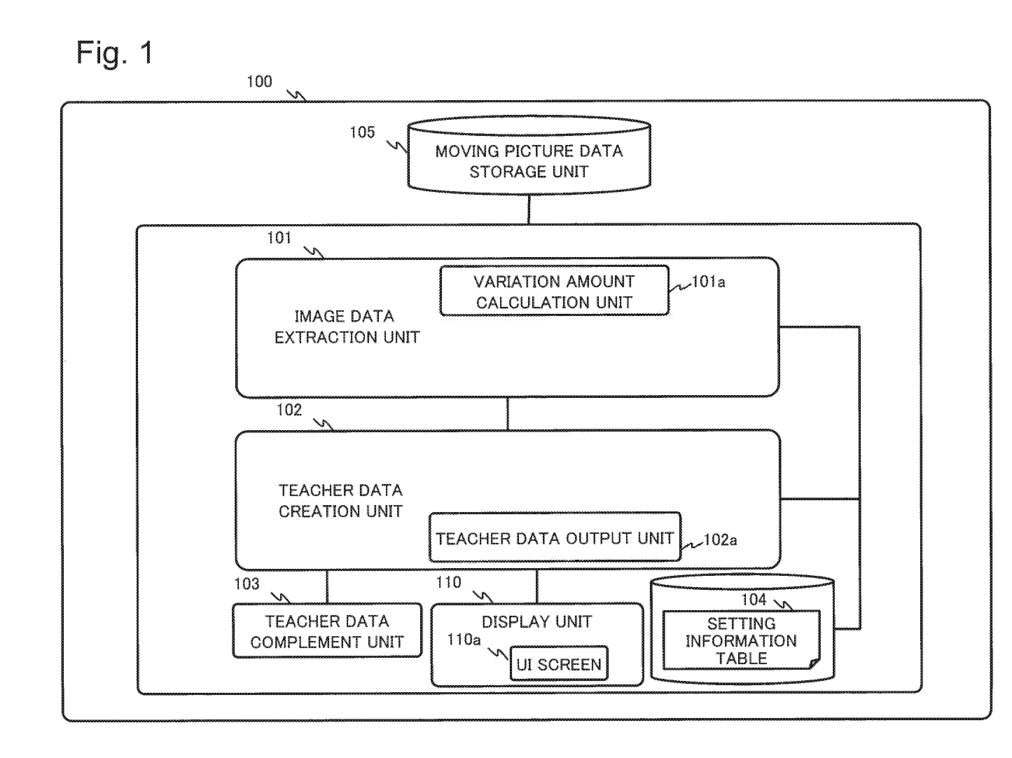

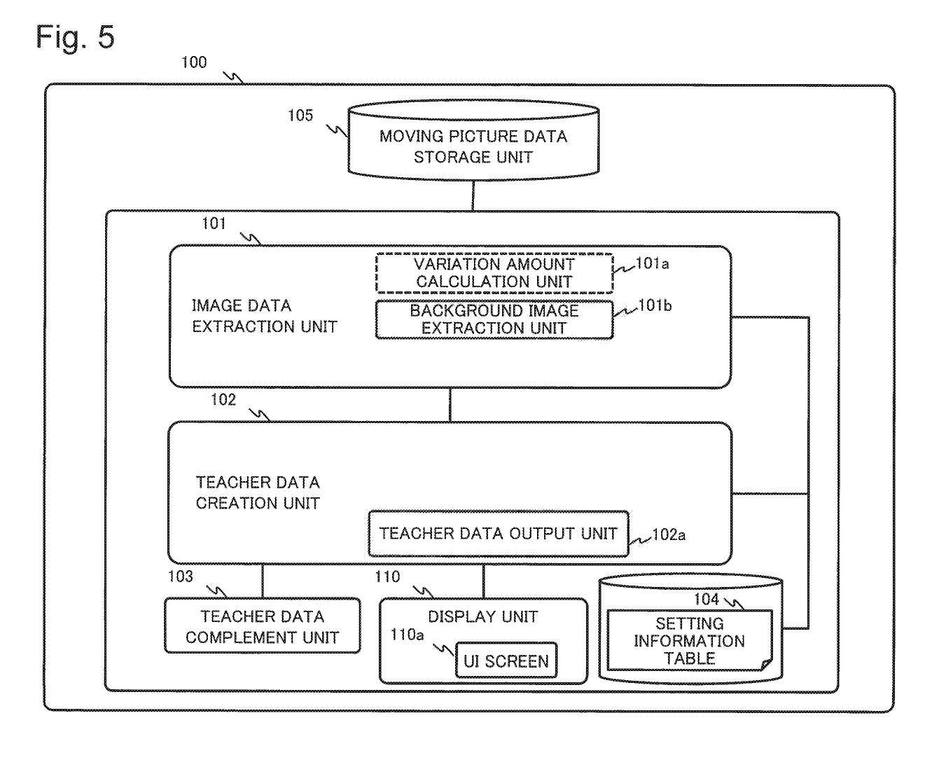

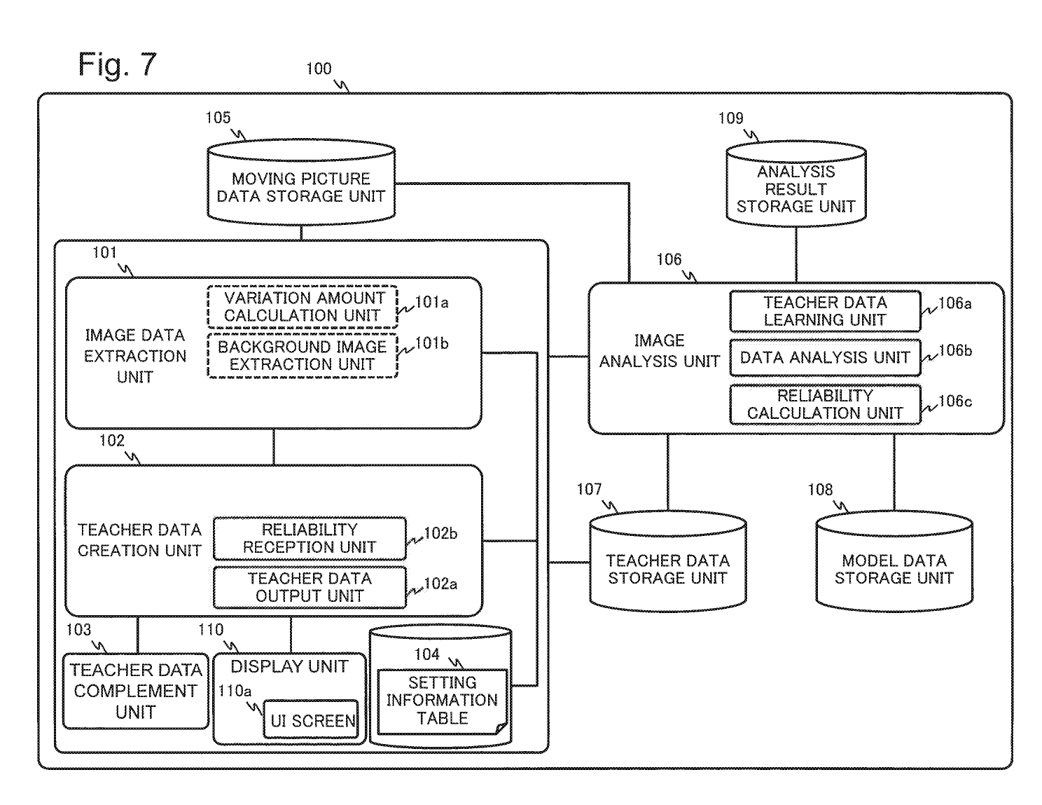

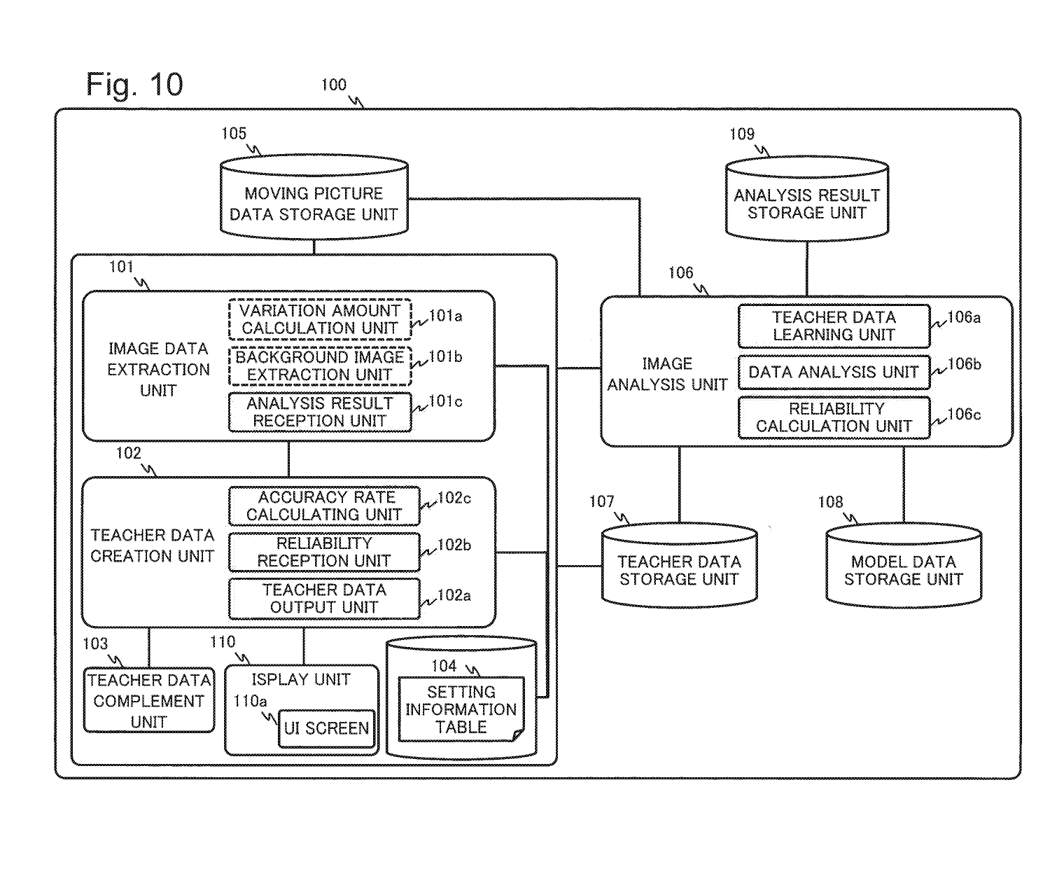

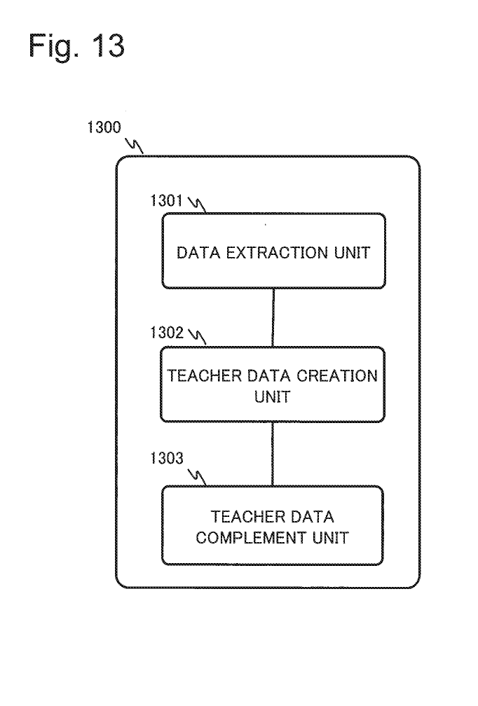

Further, the block diagrams (FIG. 1, FIG. 5, FIG. 7, FIG. 10, and FIG. 13) referred to in the explanation of each exemplary embodiment illustrates functional blocks. Although, in these figures, a data processing apparatus of each exemplary embodiment is realized with single apparatus. However each exemplary embodiment is not limited to the configuration. That is, those exemplary embodiments may be realized by configuration such like functional blocks are physically or logically separated.

### First Exemplary Embodiment

A data processing apparatus 100 according to a first exemplary embodiment of the present invention will be described with reference to FIG. 1.

The data processing apparatus 100 includes an image data extraction unit 101, a teacher data creation unit 102, a teacher data complement unit 103, and a setting information table 104. The data processing apparatus 100 may further include a moving picture data storage unit 105 and a display unit 110. Each component of the data processing apparatus 100 will be described below.

The image data extraction unit 101 extracts the still image used for the creation of the teacher data, from the moving picture data. Hereinafter, the still image extracted by the image data extraction unit 101 may be described as “candidate of the teacher data” or “teacher-data-candidate”. Further, the moving picture data from which the teacher-data-candidate is extracted may be described as “original moving picture data” or “original data”. The teacher-data-candidate may be the data of the still image at the specific timing, included in the original moving picture data that is the time series data. For example, the specific timing may be a periodic timing, or may be indicated by an instruction from a user or setting, and the like.

The image data extraction unit 101 includes a variation amount calculation unit 101a that obtains (calculates) an variation amount of an image for each scene in the moving picture data.

The teacher data creation unit 102 creates the teacher data by assigning a label to the still image (the teacher-data-candidate) extracted by the image data extraction unit 101.

The teacher data creation unit 102 may display the teacher-data-candidate to the user of the data processing apparatus 100, a system administrator, or the like (hereinafter referred to as “user”) by using the display unit 110. The teacher data creation unit 102 assigns the label to the teacher-data-candidate. The label is input (selected) by the user to each displayed teacher-data-candidate. A method for displaying the teacher-data-candidate to the user will be described later.

The teacher data creation unit 102 includes a teacher data output unit 102a which outputs the created teacher data.

The teacher data complement unit 103 may extract a still image data, to which the label is not assigned by the teacher data creation unit 102, from the moving picture data as an additional teacher-data-candidate, as necessary. The label is given to the additional teacher-data-candidate according to a specific condition.

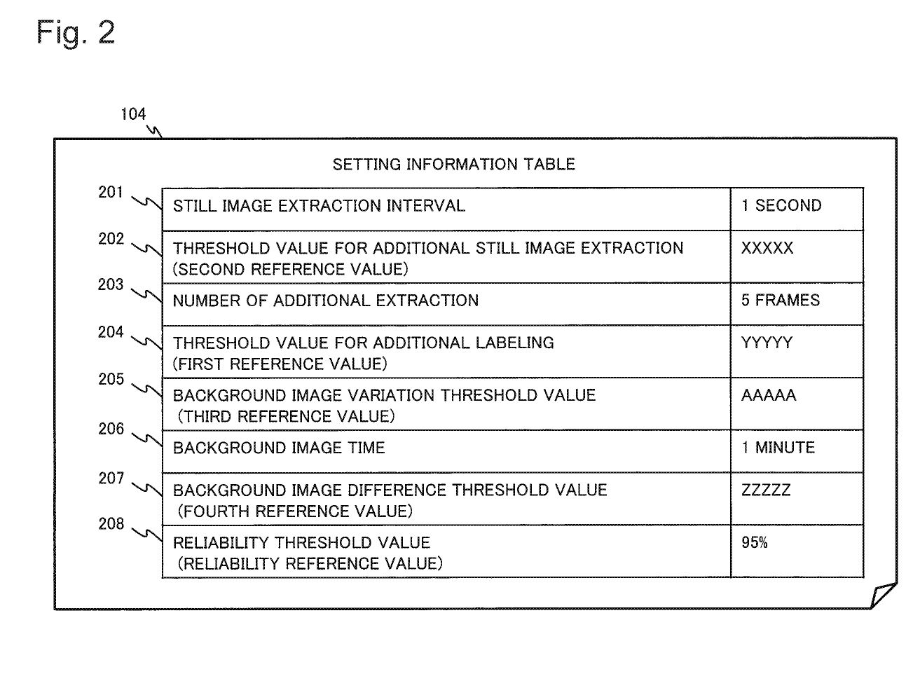

The setting information table 104 includes various setting information used for the creation of the teacher data. FIG. 2 illustrates specific example of information set to the setting information table 104. In FIG. 2, threshold values used for the creation of the teacher data (a threshold value for additional still image extraction (202)) is set to the table. The threshold value for additional still image extraction (202) may be referred as “second reference value”. Also, in FIG. 2, a threshold value for additional labeling (204) is set to the table. The threshold value for additional labeling 204 may be referred as “first reference value”. Also, in FIG. 2, a background image variation threshold value (205) is set to the table. The background image variation threshold value (205) may be referred as “third reference value”. Also, in FIG. 2, a background image difference threshold value (207) is set to the table. The background image difference threshold value (207) may be referred as “fourth reference value”. Also, in FIG. 2, a reliability threshold value (208) is set to the table. The reliability threshold value (208) may be referred as “reliability reference value”. Each threshold value exemplary shown in FIG. 2 may be set in advance, based on a preliminary experiment executed in a development phase or an operation phase of the apparatus, the accumulated past data, the user's request, or knowledge of development engineer, or the like. Each setting information shown in FIG. 2 will be described in detail later. A data structure of the setting information table 104 for storing the above-mentioned setting information is not limited to a structure of table shown in FIG. 2. The setting information table 104 may store each of the setting information by an arbitrary data format.

The moving picture data storage unit 105 stores the moving picture data (hereinafter, referred as “original data”) that is a base of the teacher data. The teacher data are created on the basis of the original data. The moving picture data (original data) from which the teacher data is extracted are collected in advance and stored in the moving picture data storage unit 105. For example, the moving picture data storage unit 105 may be composed of an arbitrary database, a file system, and the like.

The display unit 110 includes a UI screen 110a that shows a UI (User Interface) on which the teacher-data-candidate is displayed to the user. For example, the display unit 110 displays the teacher-data-candidate on the UI screen 110a according to the process executed by the teacher data creation unit 102, and receives the input from the user. The display unit 110 may notify the teacher data creation unit 102 of the input received from the user. The display unit 110 may be composed of known screen display apparatus or the like. The display unit 110 realizes an interface displaying method which can provide an interface which displays the teacher data to the user.

The above-mentioned components of the data processing apparatus 100 are connected to each other by known communication methods (a communication bus, a communication network, or the like) so as to be communicable with each other.

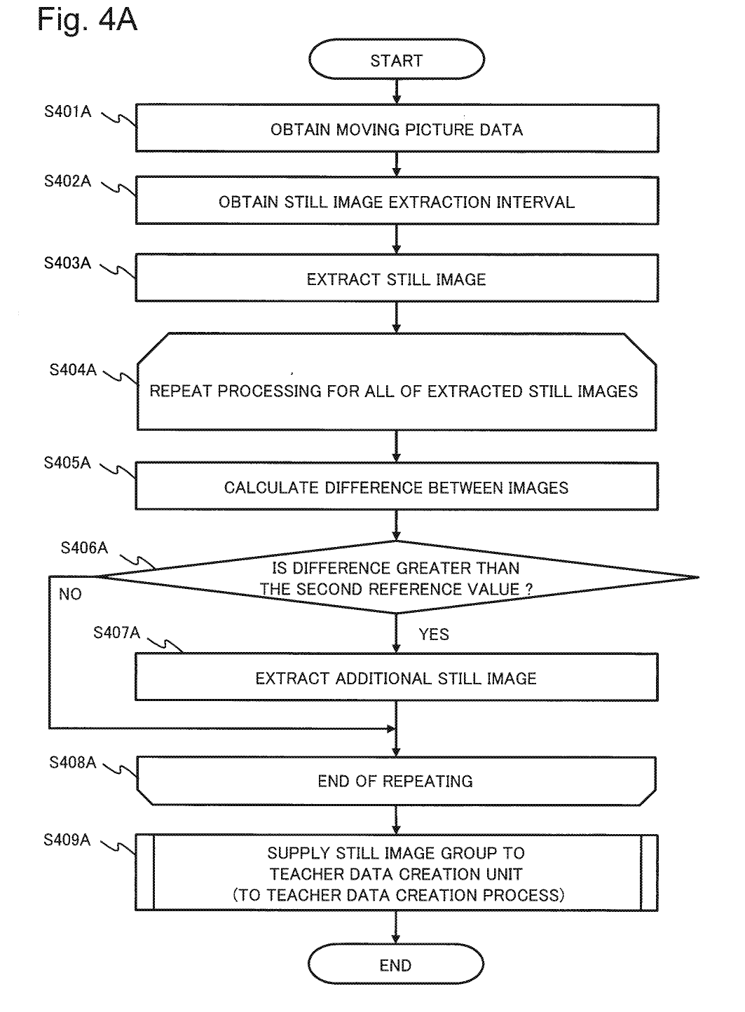

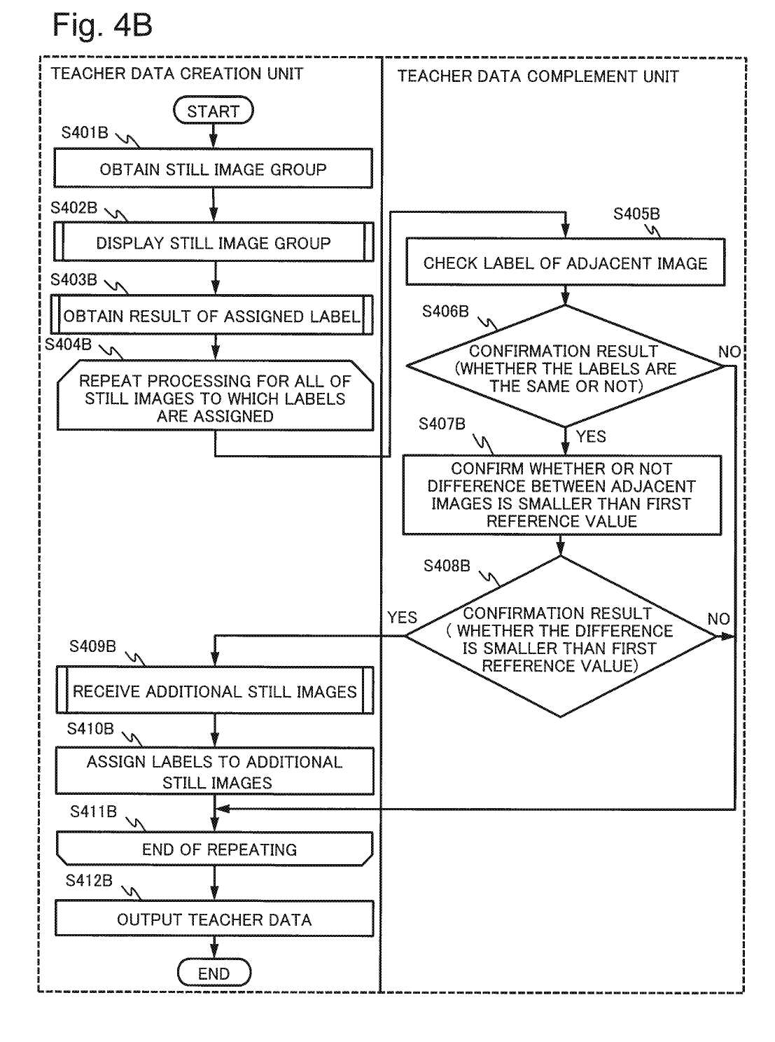

The operation of the data processing apparatus 100 according to this exemplary embodiment, configured as described above, will be described below with reference to a flowchart illustrated in FIG. 4A and FIG. 4B as an example. FIG. 4A is a flowchart exemplary illustrating a process for creating a still image group (a teacher-data-candidate) by the image data extraction unit 101 according to this exemplary embodiment. FIG. 4B is a flowchart exemplary illustrating a process for creating the teacher data by the teacher data creation unit 102.

First, the image data extraction unit 101 obtains the moving picture data stored in the moving picture data storage unit 105 (Step S401A). The moving picture data is the original data used for creating the teacher data for the learning process of the machine learning system. For example, the image data extraction unit 101 may refer to or obtain a part of or all of moving picture data stored in the moving picture data storage unit 105 on the basis of the request of the user (not shown).

Next, the image data extraction unit 101 refers to the setting information table 104 and reads a time interval (a still image extraction interval 201 shown in FIG. 2) at which the still image is extracted from the moving picture data (Step S402A). The still image extraction interval 201 may be set to the setting information table 104 by the user in advance.

The image data extraction unit 101 extracts (selects) the still image from the obtained moving picture data at the time interval set to the still image extraction interval 201 (Step 5403A).

For example, when this still image extraction interval is set to “1 second”, the image data extraction unit 101 extracts the still image from the moving picture data at the interval of one second.

There are many specific methods for extracting the still image from the moving picture data, according to the format or the like of the moving picture data. These methods may be realized by using the known technology, therefore, the detailed description about these methods will be omitted.

Next, the image data extraction unit 101 repeats execution of the process described below for each of the still images extracted at the time interval (for example, 1 second) set to the still image extraction interval 201 (Step S404A to Step S408A).

First, the image data extraction unit 101 calculates a difference between a specific still image and a still image extracted before the specific still image (Step S405A).

For example, the specific still image may be the still image at an certain timing in the moving picture data. The still image extracted before the specific still image is the still image extracted in a timing preceding in the time interval (for example, 1 second) set to the still image extraction interval 201 to the timing at which the specific still image is extracted. That is, the interval between the specific still image and the still image extracted before the specific still image is the same as still image extraction interval 201.

The image data extraction unit 101 may calculate the difference between two frames of images mentioned above by using the variation amount calculation unit 101a. For example, the variation amount calculation unit 101a may adopt the known calculation method such as an inter-frame difference method calculating a difference between the pixels of the two still images, or the like, as a method for calculating the difference between two frames of images. The calculation method is not limited to the above-mentioned method and the variation amount calculation unit 101a may calculate the difference between the images by using another known method.

In other words, it is considered that the variation amount calculation unit 101a calculates a degree of variation (change) between the specific still image and the still image extracted before the specific still image, by the above mentioned calculation of the difference.

Next, the image data extraction unit 101 determines whether or not the value of the difference between the images calculated in step S405A is greater than the threshold value (the second reference value) for additional still image extraction (the reference number “202” in FIG. 2) set to the setting information table 104 (Step S406A).

Further, the the second reference value (202) may be set to the setting information table 104 by the user in advance.

When the determination result is YES in step S406A, the image data extraction unit 101 determines that in the original moving picture data, the image recorded (captured) between the specific still image and the still image extracted before the specific still image is significantly varied.

In this case, the image data extraction unit 101 additionally extracts a plurality of still images from the moving picture data recorded between the specific still image and the still image extracted before the specific still image (for example, 1 second) (Step S407A).

As described above, the image data extraction unit 101 determines whether or not the degree of variation (the difference value of images), between the specific still image and the still image extracted before the specific still image, exceeds the second reference value. When the difference value between those two images exceeds the second reference value, a plurality of still images are further extracted from the moving picture data recorded between the specific still image and the still image extracted before the specific still image.

For example, the specific number of still images extracted in step S407A is set to the setting information table 104 as “number of additional extraction (the reference number is “203” in FIG. 2)” in advance.

The still image additionally extracted in step S407A is displayed to the user in step S402B mentioned later.

After the process in step S407A is executed, the image data extraction unit 101 continues execution of the processes from step S404A and subsequent steps.

Also, when the determination result is “NO” in step S406A, the image data extraction unit 101 continues execution of the processes from step S404A and subsequent steps.

When the process to all the images extracted in step S403A is completed (Step S408A), the image data extraction unit 101 supplies the extracted still image group to the teacher data creation unit 102 (Step S409A). Those extracted still image groups are used as the teacher-data-candidate, that are used for the creation of the teacher data.

In this case, the image data extraction unit 101 may supply (transmit) the teacher-data-candidate to the teacher data creation unit 102, or the teacher data creation unit 102 may obtain the teacher-data-candidate from the image data extraction unit 101. The teacher data creation unit 102 creates the teacher data by using the still image group (the teacher-data-candidate).

Note that, in step S406A, the image data extraction unit 101 may determine whether or not the difference value of images is greater than the predetermined reference value (the second reference value). Or, the image data extraction unit 101 may determine whether or not the difference value of images is equal to or greater than the predetermined reference value.

Next, the process for creates the teacher data by the teacher data creation unit 102 will be described.

First, the teacher data creation unit 102 obtains the still image group (the teacher-data-candidate) extracted by the image data extraction unit 101 from the image data extraction unit 101 (Step S401B).

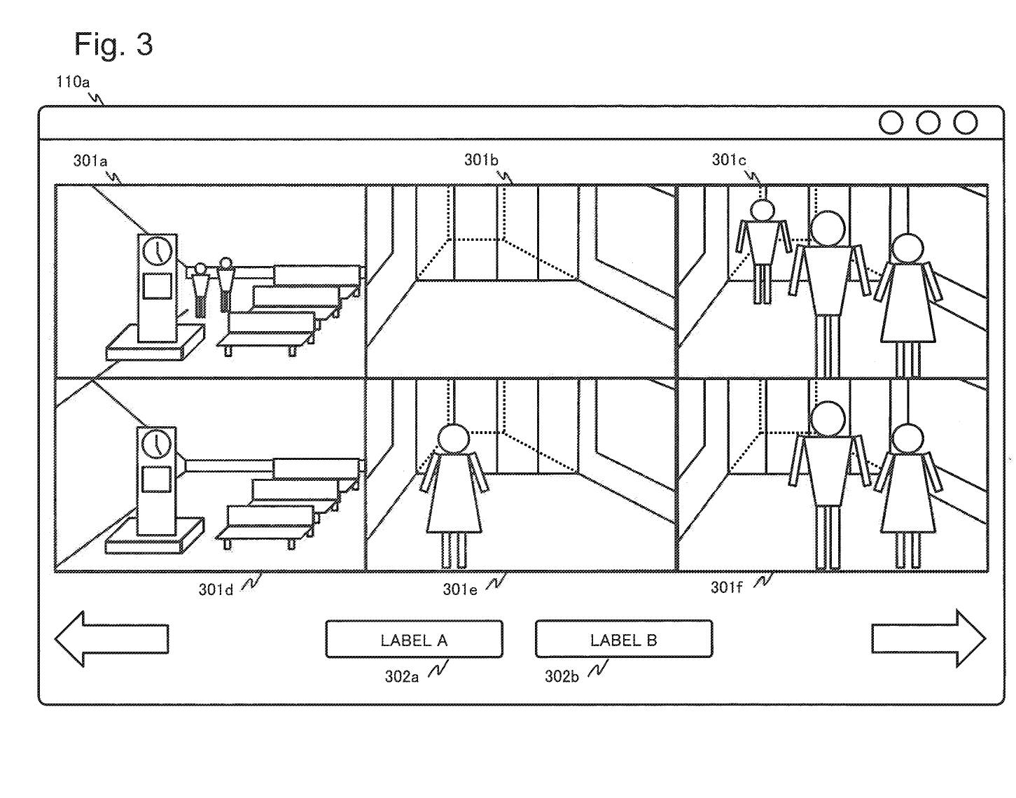

Next, the teacher data creation unit 102 displays the still image included in the obtained still image group, that are the teacher-data-candidates, on the UI screen 110a (Step S402B). As illustrated in FIG. 3 as an example, the teacher data creation unit 102 may consecutively display the still image included in the still image group on the UI screen 110a.

The user executes labeling processes appropriately, for each of the displayed still images, while referring to the display screen. Specifically, for example, the user may select one of the still images (301a to 301f) displayed on the UI screen 110a, and assigns the label to the selected still image by pressing a button (302a or 302b) indicating the label. Further, the content displayed on the UI screen 110a is not limited to the content shown in FIG. 3 as an example and an arbitrary content in which the user can give the label to the still image can be used.

Next, the teacher data creation unit 102 obtains a result of the labeling (assignment of the label) to the displayed still image (the displayed teacher-data-candidate) (Step S403B). In this case, the display unit 110 may notify the teacher data creation unit 102 of the label assigned to each still image. Or, the teacher data creation unit 102 may obtain the label assigned to each still image from the display unit 110.

Next, in step S404B to step S411B, the teacher data creation unit 102 and the teacher data complement unit 103 add the additional still image to the teacher data, as necessary. This process will be described below.

First, the teacher data complement unit 103 confirms the labels of two teacher-data-candidates that are adjacent to each other among the still images (teacher-data-candidates) that are labeled in step S401B to step S403B (Step S405B). Here, two teacher-data-candidates that are adjacent to each other are, for example, the still images that are adjacent to each other in time series among the still images extracted from the original moving picture data.

When the labels assigned to two teacher-data-candidates that are adjacent to each other are the same (YES in step S406B), the teacher data complement unit 103 confirms whether or not the difference between two teacher-data-candidates is smaller than (or, is equal to) the first reference value (the reference number “204” shown in FIG. 2) (Step S407B).

For example, the first reference value (the reference number 204 in FIG. 2) may be set to the setting information table 104 by the user in advance. The teacher data complement unit 103 reads the first reference value (the reference number 204 in FIG. 2), set to the setting information table 104.

It is considered that the teacher data complement unit 103 confirms a degree of variation between one teacher-data-candidate to another teacher-data-candidate that are adjacent to each other in time series, in step S407B.

Next, when the difference between the two teacher-data-candidates is smaller than the first reference value (YES in step S408B), the teacher data complement unit 103 determines that the label assigned to the two teacher-data-candidates may also be assigned to still images recorded in the recoding section between the two teacher-data-candidate. That is, the teacher data complement unit 103 determines that, in the original moving picture data, the label same as the label assigned to two teacher-data-candidates can be also assigned to the still image recorded between the two teacher-data-candidates.

The teacher data complement unit 103 notifies the teacher data creation unit 102 of a result of determination.

When the teacher data creation unit 102 receives the notification above, the teacher data creation unit 102 receives the still image that are existing between the two still images (two teacher-data-candidates) from the image data extraction unit 101 (Step S409B).

In step S409B, for example, the teacher data creation unit 102 may notify the image data extraction unit 101 of information for specifying the timing when the two still images (two teacher-data-candidates) are recorded in the original moving picture data. When the image data extraction unit 101 receives the notification, the image data extraction unit 101 extracts the still image included in a recording section (hereinafter, referred to as a “first additional extraction section”) existing between the two still images, of the original moving picture data. The image data extraction unit 101 supplies the extracted still image to the teacher data creation unit 102.

The number of images extracted by the image data extraction unit 101 from the images included in the first additional extraction section may be arbitrarily determined. That number of images may be set to the setting information table 104 in advance. For example, the number of images may be equal to the number of all recording frames recorded in the first additional extraction section as the moving picture data. In this case, for example, when the number of recording frames of the moving picture data is 30 frames per second and the length of the first additional extraction section is 1 second, the image data extraction unit 101 additionally extracts 30 (thirty) pieces of still images and supplies them to the teacher data creation unit 102.

The teacher data creation unit 102 assigns the label. that is the same as the label assigned to the two still images (teacher-data-candidates) that are adjacent to each other, to the additional still image received in step S409B (Step S410B).

When the determination result is “NO” in step S406B or the determination result is “NO” in step S408B, the teacher data creation unit 102 and the teacher data complement unit 103 continues execution of the processes in step S404B and subsequent steps.

When the processes in the above-mentioned steps are executed to all of still images (Step S411B), the teacher data creation unit 102 outputs the teacher-data-candidate to which the label is assigned, as the teacher data (Step S412B). The created teacher data is output from the teacher data output unit 102a. The destination of the teacher data output from the teacher data output unit 102a may be properly determined.

The data processing apparatus 100 according to this exemplary embodiment configured as above is able to extract the still image from the moving picture data that is a base of the teacher data, at the specific time interval. For example, when the still image is extracted from the moving picture data at an interval of 1 second, and when the number of recording frames of the original moving picture data is 30 frames per second, the number of the still images, that are manually labeled, is reduced by one-thirtieth.

Thus, by using the data processing apparatus 100 according to this exemplary embodiment, the number of the still images which is labeled actually by the user can be reduced, compared to the number of all of still images included in the moving picture data.

Here, if the number of the images that are a target of labeling process is simply reduced, an amount of the created teacher data possibly decrease.

In contrast, the data processing apparatus 100 according to this exemplary embodiment assigns the label, that is the same as two extracted still images (teacher-data-candidates), to the images existing between the recording timing of the two still images, when the difference between the two still images is smaller than the first reference value. That is, the data processing apparatus 100 according to this exemplary embodiment extracts additional teacher-data-candidates from the time series data (in this exemplary embodiment, the moving picture data), that exists between the two extracted still images, on the basis of the degree of variation between one of the extracted still images and the other of the extracted still images. Then, the data processing apparatus 100 according to this exemplary embodiment assigns the label, that is similar to the label assigned to the two still images, to the extracted teacher-data-candidates.

As a result, the data processing apparatus 100 according to this exemplary embodiment is able to prevent the decrease in the number of the teacher data, and also able to create the appropriate number of the teacher data.

Further, when the difference between two frames of still images extracted at the specific time interval (the still image extraction interval 201) is greater than the second reference value, the data processing apparatus 100 according to this exemplary embodiment additionally extracts the still image from the moving picture data included in the recording section existing between two still images. This process is equivalent to extracting the still images from the moving picture data at a time interval shorter than the above-mentioned specific time interval (such like the still image extraction interval 201).

The content of the images recorded in the moving picture data varies in a short time interval, when the image varies significantly. In this case, in order to create the appropriate teacher data, it may be desirable to extract the still image from the original moving picture data in a short time interval.

The data processing apparatus 100 according to this exemplary embodiment is able to reduce a number of still images, that are the target of manually labeling process, by extracting still images at constant time interval from the moving picture data, when the variation between images are small. Further, the data processing apparatus 100 according to this exemplary embodiment is able to create appropriate teacher data by extracting still images at a shorter time interval from the moving picture data, when the variation between images are significantly large.

As described above, the data processing apparatus 100 according to this exemplary embodiment is able to create the teacher data efficiently, by extracting data from the moving picture data, that is the time series data, on the basis of the specific criterion measure (for example, the still image extraction interval 201, the first reference value 204, the second reference value 202, and the like) and providing classifying (labeling) method for the extracted data.

### Modified Embodiment of First Exemplary embodiment

Next, a modified embodiment of the first exemplary embodiment will be described. The configuration of the data processing apparatus 100 according to this modified embodiment may be similar to that of the data processing apparatus 100 according to the first exemplary embodiment.

In the first exemplary embodiment, the variation amount calculation unit 101a calculates the difference between two still images extracted from the moving picture data at the specific time interval (the still image extraction interval 201).

The variation amount calculation unit 101a according to this modified embodiment may calculate a degree of similarity, that indicates how much those two still images are similar to each other. Further, the degree of similarity may also indicate a degree of variation between one of the two still images and the other of the two still images.

In this case, for example, when the degree of similarity between two still images is smaller than a first similarity criterion (in other words, when the degree of similarity is low), the image data extraction unit 101 may extract the additional still image. The first similarity criterion may be stored in the setting information table 104, by the user in advance. When the degree of similarity between two frames of still images is smaller than the first similarity criterion, the difference between the images is large.

In the first exemplary embodiment, the teacher data complement unit 103 confirms the difference between two still images that are adjacent to each other in time series (Step S407B).

In contrast, the teacher data complement unit 103 according to this modified embodiment may confirm the degree of similarity between two still images that are adjacent to each other in time series. It may be considered that the degree of similarity indicates the degree of variation between two still images that are adjacent to each other in time series.

In this case, for example, when the degree of similarity between two still images that are adjacent to each other in time series is greater than a second similarity criterion (in other words, when the degree of similarity is high), the teacher data complement unit 103 may additionally extract a candidate of a teacher data from the moving picture data which exists between two frames of still images. The second similarity criterion may be stored in the setting information table 104 by the user in advance. When the degree of similarity between two still images is greater than the second similarity criterion, the difference between the images is small.

The image data extraction unit 101 and the teacher data complement unit 103 may calculate the degree of similarity between two still images by using an arbitrary known technology. The data processing apparatus 100 according to this modified embodiment configured as above provides an effect similar to that of the data processing apparatus 100 according to the first exemplary embodiment.

### Second Exemplary Embodiment

Next, a second exemplary embodiment of the invention of the present application will be described with reference to FIG. 5. A characteristic configuration in this exemplary embodiment will be described below. The same reference numbers are used for the elements same as the first exemplary embodiment, and the detailed description thereof will be omitted.

First, an outline of this exemplary embodiment will be described. For example, when the moving picture data is a video data recorded by a security camera or the like, an image the recorded in the video data may be classified as an image (a scene) in which a moving object such as a person, a car, or the like is recorded, and an image (a scene) in which a moving object is not recorded. Hereinafter, the still image in which the moving object is not recorded may be referred as a “background image”.

When the difference between the still image extracted from the moving picture data and the background image is large, it can be determined that the large moving object (that is, a ratio of an image area of the moving object to the entire image area is large) is recorded in the still image. In contrast, when the difference between the still image and the background image is small, it can be determined that the large moving object is not recorded in the still image.

As a result, it may be determined whether or not the still image is to be extracted as the teacher-data-candidate, on the basis of the size of the moving object in the image, aside from the variation (or intensity) of a motion.

For example, assuming a case that a video data is analyzed by a machine learning system which has executed learning process using images including a small moving object (a ratio of an image area of the moving object to the entire image area is small) as the teacher data. In that case, an analysis result with sufficient accuracy may not be obtained. That is, because the size of the moving object is small in the image, it is difficult for the machine learning system to accurately classify the object. Therefore, the accuracy of the image analysis process may decrease.

The data processing apparatus 100 according to this exemplary embodiment excludes such image data from the teacher-data-candidate. As a result, the data processing apparatus 100 according to this exemplary embodiment is able to reduce the amount of data to which labeling is performed manually, and therefore is able to realize an efficient operation. Further, the data processing apparatus 100 according to this exemplary embodiment is able to provide an appropriate teacher data which does not cause the decrease in accuracy of the analysis result.

The specific configuration of the data processing apparatus 100 according to this exemplary embodiment will be described below.

In this exemplary embodiment, the image data extraction unit 101 of the data processing apparatus 100 according includes a background image extraction unit 101b. This is a difference between the data processing apparatus 100 according to the first exemplary embodiment and the data processing apparatus 100 according to this exemplary embodiment.

The background image extraction unit 101b picks (extracts) a scene in which the moving object is not recorded, as the background image, from the moving picture.

Specifically, for example, the background image extraction unit 101b determines that a recording section, that satisfies the following conditions (A) and (B), in the moving picture data, that is a base of the teacher data, as the recording section including recorded background image.

(A): An amount of variation in the a certain recording section that is included in the moving picture data is smaller than the third reference value (the reference number “205” in FIG. 2).

(B): Such recording section continues for more than a period indicated by a background image time (the reference number “206” in FIG. 2).

Further, the reference value, that is used to determine whether or not the above-mentioned conditions (A) and (B) are satisfied, may be set to the setting information table 104 in advance.

Without being limited to above mentioned method, the background image extraction unit 101b may extract the background image from the moving picture by using the known technology (the background difference method or the like).

The configuration of the data processing apparatus 100 according to this exemplary embodiment other than the configuration described above may be similar to that of the data processing apparatus 100 according to the first exemplary embodiment. Therefore, the detailed description will be omitted.

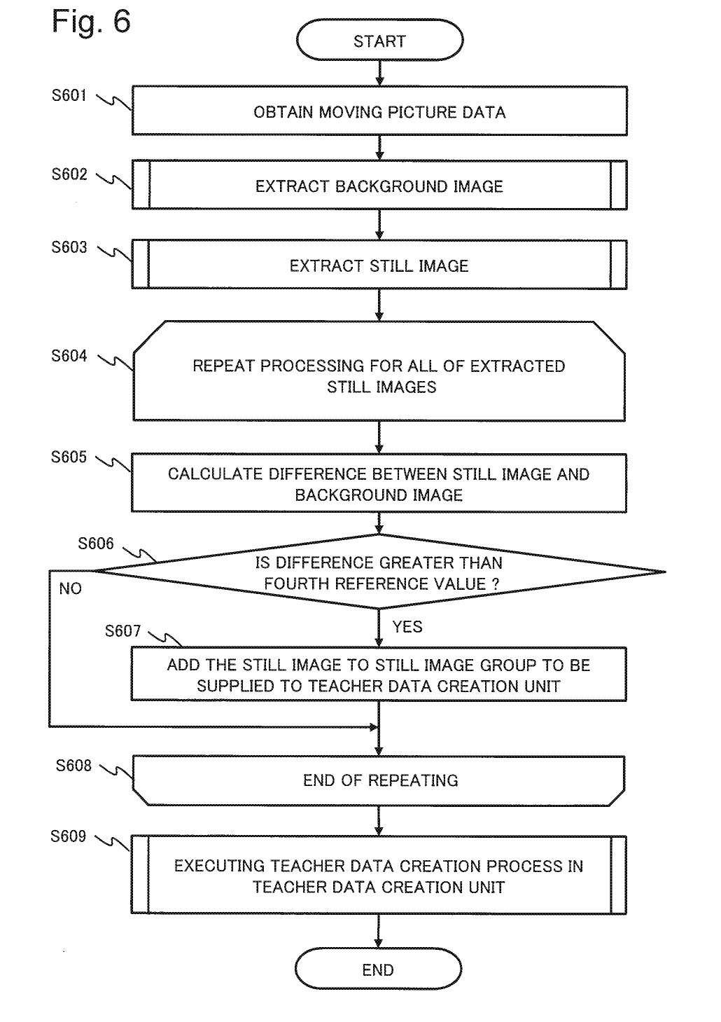

The operation of the data processing apparatus 100 according to this exemplary embodiment will be described with reference to the flowchart illustrated in FIG. 6.

First, the image data extraction unit 101 obtains the moving picture data, that is the original data of the teacher data, from the moving picture data storage unit 105, as same as the first exemplary embodiment (Step S601).

Next, the image data extraction unit 101 extracts the background image from the moving picture data received in step S601, by operating the background image extraction unit 101b (Step S602). This background image is the still image of a scene that does not include a remarkable moving object. The process for extracting the background image in the background image extraction unit 101b has been explained above.

Next, the image data extraction unit 101 extracts the still image from the moving picture data received in step S601 (Step S603).

The process for extracting the still image in step S603 may be similar to the process (processes of step 401A to step 409A shown in FIG. 4A as an example) for extracting the still image by the image data extraction unit 101 in the first exemplary embodiment.

Next, the image data extraction unit 101 repeats the following process to each still image among all the still images extracted from the moving picture data (Step S604 to Step S608).

First, the image data extraction unit 101 calculates the difference between the still image extracted in step S603 and the background image extracted in step S602 (Step S605).

When the difference calculated in step S605 is greater than the fourth reference value (the reference number 207 in FIG. 2) set to the setting information table 104 (YES in step S606), the image data extraction unit 101 determines that a moving object, which is to be analyzed, is recorded in the still image of a scene. The fourth reference value (the reference number “207” in FIG. 2) may be set to the setting information table 104 in advance.

In this case, the image data extraction unit 101 adds the still image to the still image group (the teacher-data-candidate) that is to be supplied to the teacher data creation unit 102 (Step S607).

When the difference between the extracted still image and the background image is smaller than or equal to the the fourth reference value (NO in step S606), the image data extraction unit 101 determines that a moving object, which is to be analyzed, is not recorded in the still image of a scene. In this case, the image data extraction unit 101 does not add the still image to the still image group (the teacher-data-candidate) that is supplied to the teacher data creation unit 102.

When the determination result is “NO” in step S606 and the process in step S607 is completed, in the image data extraction unit 101, the process goes back to step S604 and the process is performed to another still image extracted in step S603.

In step S606, the image data extraction unit 101 may determine whether or not the difference between the extracted still image and the background image is equal to or greater than the specific reference value (the fourth reference value).

After the repetition of processing from step S604 to step S608 are completed, the image data extraction unit 101 supplies the still image group (the teacher-data-candidate) to the teacher data creation unit 102.

When the teacher data creation unit 102 receives the teacher-data-candidate from the image data extraction unit 101, the teacher data creation unit 102 creates the teacher data on the basis of the teacher-data-candidate (Step S609). For example, the teacher data creation unit 102 may create the teacher data by the way similar to the process executed in the first exemplary embodiment.

In step S607, the image data extraction unit 101 may supply the still image to the teacher data creation unit 102 one by one, where difference value between the still image and the background image is greater than a predetermined reference value.

For example, the data processing apparatus 100 configured as described above may be adopted for an image analysis system which detects the moving object that is recorded in the video and satisfies the specific condition. Specifically, the data processing apparatus 100 may be an effective apparatus to realize purpose of creating the learning data for the machine learning system used for the image analysis system. For example, as the specific condition, an arbitrary condition such as the presence of pedestrian or the like may be set.

For example, assuming a case that an area, of the still image, in which the moving object as detection target is recorded is small, like the case that the moving object in distant location is recorded in the still image. In this case, it may be difficult to determine whether or not the detection target is recorded in the still image. If the machine learning system has executed learning process by using the teacher data based on such image, the accuracy of the image analysis (the accuracy of the object detection) may decrease. Namely, in the image analysis system using such learning system, overlooking of the target object may occur, and a false detection rate may increase. In such case that it is difficult to determine whether or not the moving object image is detection target, it is effective not to use such a moving object image as the teacher data, to prevent such defects (like overlooking or decrease in accuracy).

The data processing apparatus 100 according to this exemplary embodiment determines whether or not to add the still image to the teacher-data-candidate on the basis of whether or not the difference between the still image extracted from the moving picture data and the background image is greater than the predetermined reference value. In other words, the data processing apparatus 100 according to this exemplary embodiment determines whether or not to adopt the still image as the teacher-data-candidate on the basis of the degree of the difference between the still image extracted from the moving picture data and the background image.

As a result, in this exemplary embodiment, the still image whose difference with the background image is small (namely, it is difficult to detect the detection object) is not adopted as the teacher data. The data processing apparatus 100 according to this exemplary embodiment is able to reduce the number of the targets (still images) of labeling to the suitable size, by excluding the still image which is not suitable for the teacher data.

The data processing apparatus 100 according to this exemplary embodiment is able to execute a process similar to that of the first exemplary embodiment. Therefore, the data processing apparatus 100 according to this exemplary embodiment provides an effect similar to that of the data processing apparatus 100 according to the first exemplary embodiment.

As described above, the data processing apparatus 100 according to this exemplary embodiment is able to create the teacher data efficiently, by extracting data from the moving picture data, that is the time series data, on the basis of the specific criterion measure, and by providing classifying (labeling) method for the extracted data.

### Modified Embodiment of Second Exemplary Embodiment

Next, a modified embodiment of the second exemplary embodiment described above will be described. The configuration of the data processing apparatus 100 according to this modified embodiment may be similar to that of the data processing apparatus 100 according to the second exemplary embodiment.

In the second exemplary embodiment described above, the background image extraction unit 101b extracts the background image from the moving picture data. In contrast, in this modified embodiment, the data processing apparatus 100 creates the background image in advance for each of the moving picture data, that is the original data. The data processing apparatus 100 associates the background image created in advance with the moving picture data from which the back ground image is extracted (makes a pair of them), and stores them in the moving picture data storage unit 105.

The data processing apparatus 100 according to this modified embodiment which has the above-mentioned configuration can reduce the process needed for extracting the background image at the time of creating the teacher data, by extracting the background image in advance.

The data processing apparatus 100 according to this modified embodiment can perform the process similar to that of the the data processing apparatus 100 according to the second exemplary embodiment. Therefore, the data processing apparatus 100 according to this modified embodiment provides an effect similar to that of the data processing apparatus 100 according to the second exemplary embodiment.

### Third Exemplary embodiment

Next, a third exemplary embodiment of the present invention will be described with reference to FIG. 7. A characteristic configuration in this exemplary embodiment will be described below. The same reference numbers are used for the elements same as the first and second exemplary embodiments, and the detailed description thereof will be omitted.

First, an outline of this exemplary embodiment will be described.

The data processing apparatus 100 according to this exemplary embodiment executes learning process for the the machine learning system by using the teacher data and creates model data used for the moving picture analysis, when a certain amount of the teacher data is created.

When the data processing apparatus 100 according to this exemplary embodiment creates the teacher data additionally, the data processing apparatus 100 executes the image analysis process to the moving picture data that is a base of the teacher data, by using the created model data in advance.

Here, usually, in the image analysis using the machine learning system, “reliability”, that is data (numerical value) representing the probability (or, degree of certainty) with regard to an analysis result, is calculated. The reliability is calculated by using a proper calculation method according to a specific learning algorithm used in the machine learning system or the created model data. For example, the reliability may be represented by a probability value with regard to the result obtained by analyzing the image by an image analysis system. Namely, when the probability that a certain image belongs to a specific category is represented as “probability value N” (for example, N is equal to or greater than 0, and N is equal to or smaller than 1.), the image analysis system may use the probability value N as the reliability. For example, when the machine learning system uses the probability model, the reliability may be represented by the probability value indicating the analysis result (discrimination result). The method for calculating the reliability is not limited to the above-mentioned method, and may be appropriately selected.

When the above-mentioned reliability is high, a possibility, that the result of the image analysis is correct, is high, and when the reliability is low, possibility that the result of the image analysis is incorrect, is high. Also, it is generally known that the reliability of a result of the image analysis becomes low, when a learning amount (a number of learning data) are insufficient for the image analysis.

Hereinafter, an analysis result, obtained by executing the image analysis to the image data by using the machine learning system that has been leaned using the teacher data that is created by a certain timing, may be referred as a “pre-analysis result”.

The data processing apparatus 100 according to this exemplary embodiment determines whether or not a reliability of the pre-analysis result of an image data in which a certain scene is recorded is higher than the reference value (or, it is equal to the reference) set in advance, when creating the teacher data.

When the reliability of the pre-analysis result is higher than the reference value set in advance, the data processing apparatus 100 according to this exemplary embodiment determines that the machine learning system has already executed learning process needed to analyze the scene sufficiently. In this case, the data processing apparatus 100 according to this exemplary embodiment excludes the image data from the teacher data.

As a result, the data processing apparatus 100 according to this exemplary embodiment is able to reduce workloads for creating the teacher data. Namely, the data processing apparatus 100 according to this exemplary embodiment is able to reduce the teacher data as the learning object, when the learning amount increases according to progress of the creation of the teacher data, and the number of scenes that can be analyzed with sufficient reliability increases.

Next, the configuration of the data processing apparatus 100 according to this exemplary embodiment will be described. The data processing apparatus 100 according to this exemplary embodiment includes an image analysis unit 106, a teacher data storage unit 107, a model data storage unit 108, and an analysis result storage unit 109, in addition to the component described in the above-mentioned exemplary embodiment. The teacher data creation unit 102 according to this exemplary embodiment includes a reliability reception unit 102b. Each component will be described below.

The teacher data storage unit 107 stores the teacher data output from the teacher data output unit 102a. For example, the teacher data storage unit 107 may be composed of an arbitrary database.

The model data storage unit 108 stores the model data. The model data may be obtained by modeling the result of the learning process executed in the machine learning system by using the teacher data, that are output from the teacher data output unit 102a. For example, the model data storage unit 108 may be composed of an arbitrary file or a database.

The image analysis unit 106 according to this exemplary embodiment includes a teacher data learning unit 106a, a data analysis unit 106b, and a reliability calculation unit 106c.

Specifically, the image analysis unit 106 analyzes the moving picture data (time series data) by using the model data stored in the model data storage unit 108. By this process, the image analysis unit 106 determines the label to be assigned to the still image included in the moving picture data. Further, the image analysis unit 106 according to this exemplary embodiment calculates the reliability of the analysis result (the result of assigning the label to the still image included in the moving picture data), that is obtained by analyzing the moving picture data. Each component of the image analysis unit 106 will be described below.

The teacher data learning unit 106a executes the learning process in the machine learning system by using the teacher data stored in the teacher data storage unit 107.

The data analysis unit 106b executes the image analysis process by using the model data that is the learning result of the machine learning system.

The reliability calculation unit 106c calculates the reliability of the analysis result of the image data analyzed by the data analysis unit 106b. As described above, the reliability is a value (numerical value) indicating the probability (or degree of certainty) of the analysis result, and generally used in the image analysis system. The reliability calculation unit 106c can calculate the reliability by using the known technology.

The analysis result storage unit 109 stores the result analyzed by the image analysis unit 106. For example, the analysis result storage unit 109 may be composed of an arbitrary file or a database.

The reliability reception unit 102b in the teacher data creation unit 102 receives the reliability of the analysis result calculated by the image analysis unit 106. The teacher data creation unit 102 reflects the reliability in the process for creating the teacher data.

In this exemplary embodiment, the above-mentioned components of the data processing apparatus 100 are connected to each other by known communication methods (a communication bus, a communication network, or the like) so as to be communicable with each other.

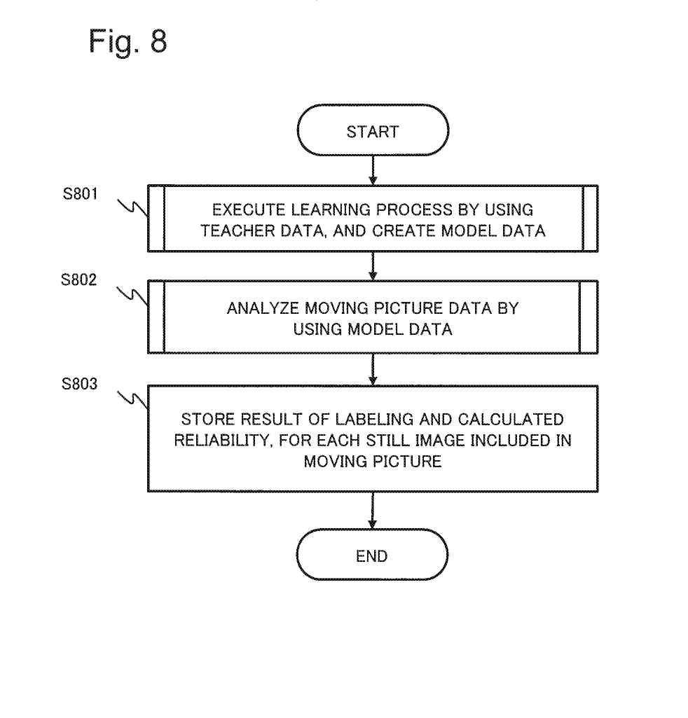

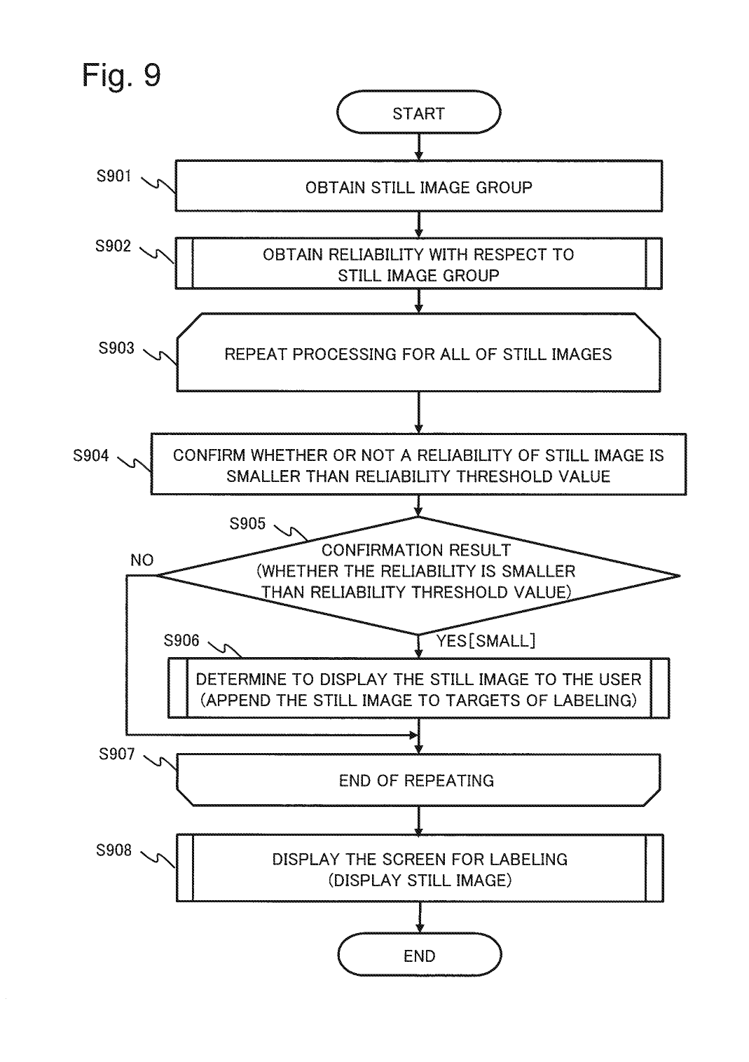

The operation of the data processing apparatus 100 according to this exemplary embodiment configured as above will be described with reference to the flowchart illustrated in FIG. 8 and FIG. 9, as an example.

First, for example, the teacher data creation unit 102 creates the teacher data by executing the process described in the each of above-mentioned exemplary embodiment. The teacher data creation unit 102 stores the teacher data (the still images that are labeled) created by using the teacher data output unit 102a, in the teacher data storage unit 107.

In this case, the teacher data output unit 102a stores the teacher data by an appropriate method according to the specific configuration of the teacher data storage unit 107. When the teacher data storage unit 107 is composed of the database, for example, the teacher data output unit 102a may store the teacher data by using a database operation language. Further, when the teacher data storage unit 107 is composed of the file, for example, the teacher data output unit 102a may append the teacher data to the file.

Next, the process executed in the image analysis unit 106 will be described with reference to the flowchart shown in FIG. 8 as an example.

At a timing at which an amount of the teacher data stored in the teacher data storage unit 107 satisfies (reaches) a predetermined amount, the image analysis unit 106 executes the learning process of the machine learning system, by using the teacher data stored in the teacher data storage unit 107. By this process, the image analysis unit 106 creates the model data (Step S801). The model data is created as the result of the learning process of the machine learning system. When this process is performed, the image analysis unit 106 stores the model data in the model data storage unit 108.

The image analysis unit 106 may execute the learning process of the machine learning system (automatically) by determining the timing at which the amount of the stored teacher data satisfies the predetermined amount by oneself. Also, the image analysis unit 106 may execute the learning process of the machine learning system in response to an instruction from an outside such as a user's instruction or the like. For example, the timing at which the learning process of the machine learning system is started (executed) may be set to the setting information table 104, by the user in advance. The image analysis unit 106 may appropriately select the specific method for performing the learning process according to the configuration of the machine learning system.

The image analysis unit 106 may execute the learning process of the machine learning system by using the teacher data learning unit 106a.

Next, the image analysis unit 106 analyzes the moving picture data stored in the moving picture data storage unit 105 by using the created model data, as mentioned above (Step S802). The moving picture data analyzed in Step S802 includes the moving picture data that is the original data on the basis of which new teacher data is created. In this case, each image (still image) composing moving picture data may be the image of each frame that composes moving picture data. For example, when the number of frames of the moving picture data is 30 frames per second, thirty pieces of still images are included in the moving picture data for one second.

The image analysis unit 106 may analyze the moving picture data by using the data analysis unit 106b. In this case, the data analysis unit 106b determines the label to be assigned to each image (still image) composing the moving picture data, by analyzing the moving picture data with using the model data. The data analysis unit 106b may assign the label to each still image on the basis of a result of determination.

When he image analysis unit 106 analyses the moving picture data by using the model data, the image analysis unit 106 calculates the reliability of the analysis result by the reliability calculation unit 106c. In this case, the reliability calculation unit 106c may calculate the reliability of the analysis result by using the known calculation method.

Next, the image analysis unit 106 stores a result of the image analysis in Step S802 for each still image composing original moving picture data, in the analysis result storage unit 109 (Step S803). The analysis result includes information representing the determining (judging) result of the labeling to the still image included in the moving picture data, and the reliability of the analysis result.

Next, a process for creating the teacher data by using the analysis result and the reliability that are stored as mentioned above will be described by using the flowchart illustrated in FIG. 9, as an example.

First, the teacher data creation unit 102 obtains the still image group (the teacher-data-candidate) from the image data extraction unit 101 (Step S901).

Next, the teacher data creation unit 102 obtains the the reliability of each still image (the teacher-data-candidate) included in the still image group obtained in step S901, from the image analysis unit 106 (Step S902). In this case, the image analysis unit 106 may extract the reliability of each still image included in the still image group, from the reliability stored in the analysis result storage unit 109, and notify the extracted reliability to the teacher data creation unit 102.

As mentioned above, the analysis result of the moving picture data that is the original data of new teacher data is stored in the analysis result storage unit 109. That is, the image analysis unit 106 can obtain the analysis result of each teacher-data-candidate and the reliability of the analysis result by referring to the analysis result storage unit 109.

Next, the teacher data creation unit 102 repeats the following processing from step S903 to step S907, for all of still images (the candidates for the teacher data) included in the still image group obtained in step S901 as mentioned above.

First, the teacher data creation unit 102 refers to the setting information table 104 and confirms whether or not the calculated reliability of a certain still image is smaller than the predetermined reliability threshold value (the reference number “208” in FIG. 2) (Step S904). The reliability threshold value may be set to the setting information table 104, by the user in advance.

When the above-mentioned reliability is equal to or greater than the predetermined reliability threshold value (NO in step S905), the teacher data creation unit 102 determines that the analysis result having sufficient reliability can be obtained by using the created model data, with regard to a scene recorded in the still image.

Namely, in this case, the analysis result having sufficient reliability can be obtained with regard to the scene taken in the still image, by using the model data created by the image analysis unit 106.

In this case, the teacher data creation unit 102 determines that it is not necessary to newly create the teacher data with regard to this scene. The teacher data creation unit 102 determines to exclude the still image from the target of labeling process which is executed by the user. In this case, the still image is not displayed on the UI screen 110a, which is used for labeling process by the user.

When the reliability of the still image is smaller than the predetermined reliability threshold value (YES in step S905), the teacher data creation unit 102 determines that the analysis result having sufficient reliability cannot be obtained with regard to the scene taken in the still image.

In this case, the teacher data creation unit 102 determines that it is necessary to create the teacher data with regard to this scene. The teacher data creation unit 102 determines to append the still image into targets of the labeling process which is executed by the user (Step S906).

When the determination result of step S905 is “NO” and the process in step S906 is completed, the teacher data creation unit 102 continues the processesing in step S903 and subsequent steps.

When the above-mentioned process is completed for all of still image groups obtained in step S901 (Step S907), the teacher data creation unit 102 displays still images, that are determined to be the target of labeling (in step S906), on the UI screen 110a used for the labeling by the user (Step S908).

The teacher data creation unit 102 may execute the processes in step S403B and subsequent steps described in the first exemplary embodiment, after executing the process in step S908.

The data processing apparatus 100 according to this exemplary embodiment determines whether or not the still image is used as the teacher data on the basis of the analysis result of the image analysis with regard to the specific still image, and the reliability of the analysis result.

The moving picture data, that are the original data of the teacher data, includes a scene of which appearance frequency is relatively high, and a scene of which appearance frequency is relatively low. Therefore, as the teacher data created from the moving picture data increases, the amount of the created teacher data differs according to the scene that appears in the moving picture data. That is, there are two types of the scenes. One is a scene for which learning process is sufficiently executable by a sufficient amount of the teacher data is created. And the other is a scene for which a lot of further teacher data are required, because an amount of the created teacher data is insufficient.

Accordingly, the data processing apparatus 100 according to this exemplary embodiment creates the model data by executing the learning process of the machine learning system, by using the teacher data created by a certain timing. The data processing apparatus 100 according to this exemplary embodiment executes the analysis process of the moving picture data that is the original data of new teacher data by using the model data.

The data processing apparatus 100 according to this exemplary embodiment adds the still image, that the scene with low reliability is recorded, to the teacher-data-candidate on the basis of the analysis result. That is, the data processing apparatus 100 selects the still image with regard to the scene of which teacher data is insufficient, as the new teacher-data-candidate

As a result, the data processing apparatus 100 according to this exemplary embodiment is able to efficiently create the substantial teacher data.

The data processing apparatus 100 according to this exemplary embodiment is able to execute a process similar to the process executed by the data processing apparatus 100 according to the above-mentioned exemplary embodiment. Therefore, the data processing apparatus 100 according to this exemplary embodiment provides an effect similar to that of the data processing apparatus 100 according to the above-mentioned exemplary embodiment.

As described above, the data processing apparatus 100 according to this exemplary embodiment is able to create the teacher data efficiently, by extracting data from the moving picture data, that is the time series data, on the basis of the specific criterion measure (for example, in this exemplary embodiment, the reliability threshold value) and by providing classifying (labeling) method for the extracted data.

### Modified Embodiment of Third Exemplary Embodiment

Next, a modified embodiment of the third exemplary embodiment will be described. The configuration of the data processing apparatus 100 according to this modified embodiment may be similar to that of the data processing apparatus 100 according to the third exemplary embodiment. In this modified embodiment, the operation of the image analysis unit 106 is partially different from the operation of the image analysis unit 106 according to the third exemplary embodiment. The difference will be described below.

The image analysis unit 106 according to the third exemplary embodiment executes the learning process of the machine learning system by using the teacher data stored in the teacher data storage unit 107, at the timing at which the amount of the teacher data stored in the teacher data storage unit 107 satisfies the predetermined amount. By this process, the image analysis unit 106 according to the third exemplary embodiment creates the model data (Step S801).

The image analysis unit 106 according to the third exemplary embodiment analyzes the moving picture data stored in the moving picture data storage unit 105 by using the created model data (Step S802).

The image analysis unit 106 according to this modified embodiment creates the model data by performing the process in step S801, same as the third exemplary embodiment.

In the step S902, the image analysis unit 106 according to this modified embodiment may calculate the reliability of each still image included in the still image group, when the reliability of the still image is required by the teacher data creation unit 102.

In the other words, the image analysis unit 106 according to the third exemplary embodiment calculates the reliability in advance, by analyzing the moving picture data stored in the moving picture data storage unit 105 by using the model data created at the predetermined timing. In contrast, the image analysis unit 106 in this modified embodiment calculates the reliability of each still image, when the image analysis unit 106 according to this modified embodiment is requested to transmit the the reliability of the specific still image by the teacher data creation unit 102. Therefore, the data processing apparatus 100 according to this modified embodiment is able to reduce the calculation amount required for calculating the reliability.

Also, the data processing apparatus 100 according to this modified embodiment has a configuration similar to that of the data processing apparatus 100 according to the third exemplary embodiment. Therefore, the data processing apparatus 100 according to this modified embodiment provides an effect similar to that of the data processing apparatus 100 according to the third exemplary embodiment.

### Fourth Exemplary embodiment

Next, a fourth exemplary embodiment of the invention of the present application will be described with reference to FIG. 10. A characteristic configuration in the exemplary embodiment will be described below. The same reference numbers are used for the elements having the same function as the above-mentioned exemplary embodiments and the detailed description will be omitted.

First, an outline of this exemplary embodiment will be described.

Generally, in some case, it is difficult for the user to determine whether or not the teacher data used for the learning of the machine learning system is sufficient. That is, it is not easy for the user to determine an amount or a quality of the teacher data required for the learning process of the machine learning system that is expected to obtain the analysis result with sufficient accuracy with respect to the data that is the analysis target. In this case, for example, it is necessary for a specialist (engineer) with expertise and knowledge to determine whether or not the amount and the quality of the teacher data are sufficient, by repeating a trial and error process according to the situation of using the data analysis system.

In contrast, the data processing apparatus 100 according to this exemplary embodiment not only creates the teacher data of the machine learning system but also provides the information by which the user can determine whether or not the created teacher data is sufficient.

Specifically, the data processing apparatus 100 according to this exemplary embodiment provides, to the user, the result of the image analysis executed by the machine learning system that has executed the learning process by using the teacher data created by a certain timing. As a result, the data processing apparatus 100 according to this exemplary embodiment enables the user to understand whether or not the created teacher data is sufficient. Therefore, the user can determine whether or not to finish the creation of the teacher data. Further, the user can also determine whether or not the additional creation of the teacher data is effective to the image analysis.

The data processing apparatus 100 according to this exemplary embodiment starts the learning process by the machine learning system, when the predetermined amount of the teacher data is created. The data processing apparatus 100 according to this exemplary embodiment executes the analysis process, on the basis of the learning result, for the moving picture data, that is the original data of new teacher data. The data processing apparatus 100 according to this exemplary embodiment may execute this analysis process before creating the new teacher data.

For example, the analysis process of the moving picture data is a process to determine a label for classifying the image, with regard to each image data (the teacher-data-candidate) included in the moving picture data.

The data processing apparatus 100 according to this exemplary embodiment records the result of the analysis process. When creating the new teacher data, the data processing apparatus 100 according to this exemplary embodiment compares the recorded analysis result with the determination result of the new teacher data (the label assigned to the new teacher data), which is determined by the user. The data processing apparatus 100 according to this exemplary embodiment determines that the analysis result is correct when the determination result is the same as the analysis result, and the analysis result is incorrect when the determination result is different from the analysis result. Based on the determination, the data processing apparatus 100 according to this exemplary embodiment calculates an accuracy rate (a rate of correct answer) of the analysis result, and provides the user with the calculated accuracy rate.

That is, the data processing apparatus 100 according to this exemplary embodiment is able to calculate the accuracy rate with respect to the analysis result of other moving picture data (that may be not included in teacher data created by the certain timing), by using the machine learning system that has executed the learning process by using the teacher data created by the certain timing.

The user can determine whether or not the amount and the quality of the teacher data are sufficient on the basis of the accuracy rate. For example, the user can continue the operation for creating the the teacher data until the accuracy rate satisfies an value set as a target in advance.

The configuration of the data processing apparatus 100 according to this exemplary embodiment will be described below.

In the data processing apparatus 100 according to this exemplary embodiment, in addition to the component described in the above-mentioned exemplary embodiment, the image data extraction unit 101 includes an analysis result reception unit 101c and the teacher data creation unit 102 includes an accuracy rate calculating unit 102c. Each component will be described below.

The analysis result reception unit 101c receives a result of analysis of the moving picture data executed by the image analysis unit 106. The analysis result reception unit 101c may obtain the analysis result from the image analysis unit 106, or from the analysis result storage unit 109.

The accuracy rate calculating unit 102c calculates the accuracy rate with regard to the the image analysis result supplied by the image analysis unit 106 (especially, the data analysis unit 106b).

In this exemplary embodiment, the above-mentioned components of the data processing apparatus 100 are connected to each other by arbitrary known communication method (a communication bus, a communication network, or the like), so as to be communicable with each other.

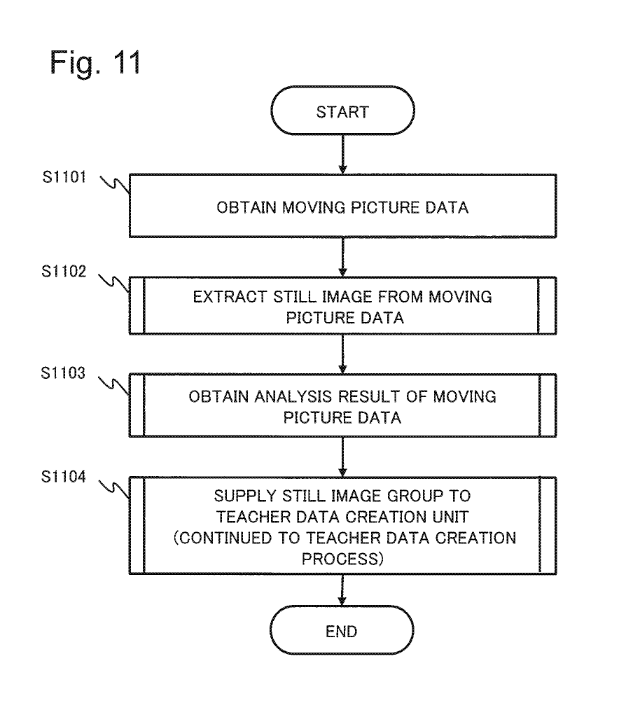

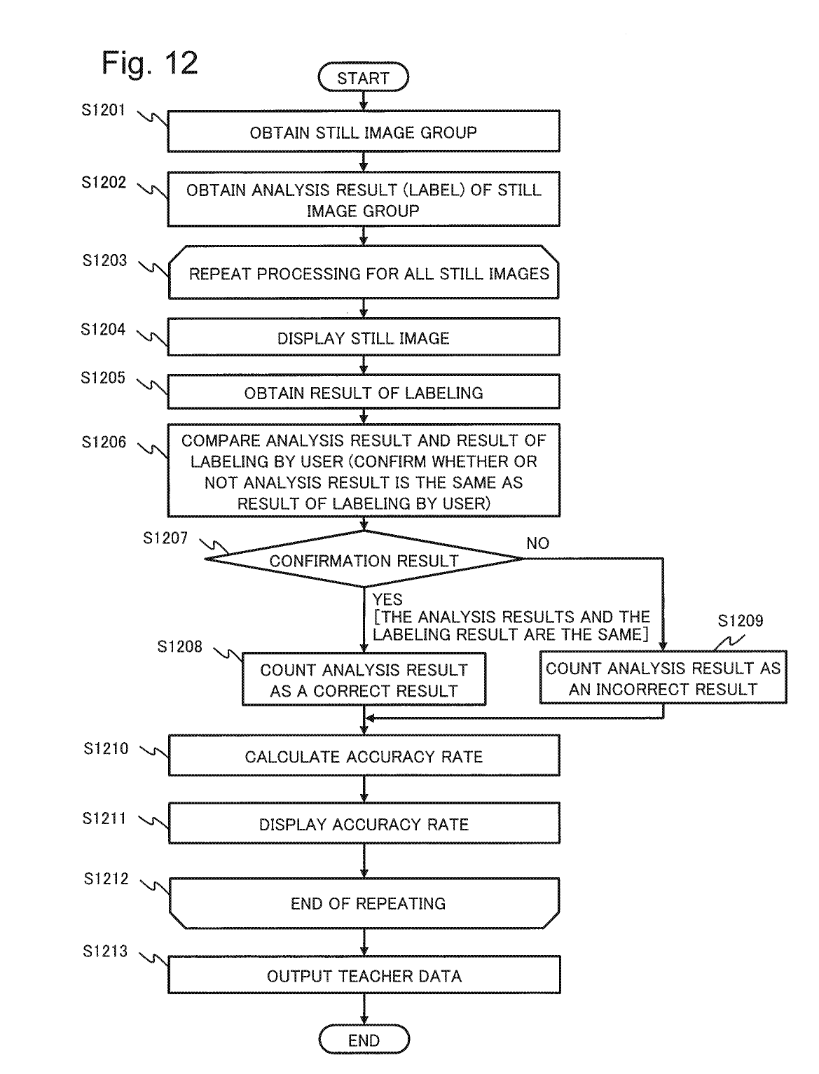

The operation of the data processing apparatus 100 according to this exemplary embodiment configured as above will be described below with reference to a flowchart illustrated in FIG. 11 and FIG. 12, as an example.

The image analysis unit 106 according to this exemplary embodiment executes the learning process of the machine learning system by using the teacher data stored in the teacher data storage unit 107 at the timing at which the amount of the created teacher data satisfies the predetermined amount, and creates the model data, like the third exemplary embodiment.

The image analysis unit 106 may determine the timing at which the amount of the stored teacher data satisfies the predetermined amount by itself, and (may automatically) execute the learning process of the machine learning system. Also, the image analysis unit 106 may execute the learning process of the machine learning system in response to an instruction from an outside, such as a user's instruction or the like.

The image analysis unit 106 stores the created model data in the model data storage unit 108.

Next, the image analysis unit 106 analyzes the moving picture data stored in the moving picture data storage unit 105, by using the created model data as mentioned above. The stored moving picture data includes, a moving picture data that is the original data of new teacher data. In this case, each scene (still image) constituting the moving picture data, may be the image of each frame constituting the moving picture data.

Next, the image analysis unit 106 stores the analysis result of the moving picture data in the analysis result storage unit 109.

The process for creating the model data and the process for analyzing the moving picture data in the image analysis unit 106 described above may be same as those of the third exemplary embodiment.

Next, the process for calculating the accuracy rate by using the stored analysis result will be described.

First, the process in the image data extraction unit 101 will be described.

The image data extraction unit 101 reads the new moving picture data from the moving picture data storage unit 105 (Step S1101).

Next, the image data extraction unit 101 extracts the still image from the moving picture data (Step S1102). A process for extracting the still image in the image data extraction unit 101 may be similar to that of the above-mentioned exemplary embodiment. Therefore, the detailed explanation will be omitted.

Next, the image data extraction unit 101 receives a result of the image analysis of the moving picture data from the image analysis unit 106 (Step S1103).

This analysis result is provided by the image analysis unit 106 (the data analysis unit 106b) analyzing the moving picture data by using the model data created as above. The analysis result includes the determination result of the label assigned to each still image constituting the moving picture data. The analysis result may be recorded in the analysis result storage unit 109 for each still image constituting the moving picture data.

In this case, the analysis result reception unit 101c in the image data extraction unit 101 may obtain (receive) the analysis result from the image analysis unit 106, or from the analysis result storage unit 109. The analysis result reception unit 101c may obtain (receive) the analysis result of the still image from the image analysis unit 106, for each still image extracted in step S1102.

The image data extraction unit 101 supplies the extracted still image group (group of the teacher-data-candidate) to the teacher data creation unit 102. At this time, the image data extraction unit 101 supplies the above-mentioned analysis result of each still image, to the teacher data creation unit 102 (Step S1104). In this case, the teacher data creation unit 102 may obtain the above-mentioned still image group and the analysis result of the still image group from the image data extraction unit 101.

Next, the process for creating the teacher data in the teacher data creation unit 102 according to this exemplary embodiment will be described with reference to FIG. 12.

The teacher data creation unit 102 obtains the still image group (the teacher-data-candidate) supplied from the image data extraction unit 101 in step S1104 (Step S1201).

Next, the teacher data creation unit 102 obtains the analysis result of each still image included in the still image group supplied from the image data extraction unit 101 in step S1104 (Step S1202). Next, the teacher data creation unit 102 repeat the processing from step S1203 to step S1212 for all the still images included in the obtained still image group.

First, the teacher data creation unit 102 displays the still image included in the still image group (the teacher-data-candidate) (Step S1204). The process in step S1204 may be same as the process in step S402B (FIG. 4B) described in the first exemplary embodiment. Therefore, the detailed explanation will be omitted.

Next, the teacher data creation unit 102 obtains a result of labeling, by the user, to the still image (the teacher-data-candidate) displayed in step S1204 (Step S1205). The process in step S1205 may be similar to the process in step S403B (FIG. 4B) described in the first exemplary embodiment. Therefore, the detailed explanation will be omitted.

Next, the teacher data creation unit 102 compares the result of labeling, by the user, which is obtained in step S1205, with the analysis result of the still image, which is obtained in step S1202 from the image data extraction unit 101, for each still image (the teacher-data-candidate) (Step S1206). As described above, the analysis result of the still image includes the determination result of the label assigned to the still image, the determination result being provided by the image analysis unit 106 (the data analysis unit 106b).

When the label assigned by the user to a certain still image is the same as the analysis result (the determination result of the label assigned to the still image) obtained from the image data extraction unit 101 (YES in step S1207), the teacher data creation unit 102 counts the analysis result as the correct result (Step S1208).

When the label assigned by the user to a certain still image is not the same as the analysis result obtained from the image data extraction unit 101 (NO in step S1207), the teacher data creation unit 102 counts the analysis result as the incorrect result (Step S1209).

The teacher data creation unit 102 calculates the accuracy rate on the basis of the result of the process in step S1208 and step S1209 (Step S1210). For example, the teacher data creation unit 102 may calculate the accuracy rate by dividing the count of the correct result by the sum of the counts.

The teacher data creation unit 102 displays the accuracy rate calculated in step S1210 to the user for example, by displaying it on the UI screen 110a shown in FIG. 3 (Step S1211).

When the process in each step mentioned above is performed to all the still image groups (the candidates for the teacher data) (Step S1212), the teacher data creation unit 102 outputs the teacher data (Step S1213). The process in step S1213 may be similar to the process in step S412B (FIG. 4B) described in the first exemplary embodiment. Therefore, the detailed explanation will be omitted.

The teacher data creation unit 102 may display accuracy rate of the each correct answer to the user after calculating the accuracy rate regarding to all the candidates for the teacher data. The method for displaying the accuracy rate is not limited to displaying on UI screen 110a as exemplary shown in FIG. 3. An appropriate method may be selected appropriately.

The data processing apparatus 100 according to this exemplary embodiment configured as above creates the model data by executing the learning process in the machine learning system by using the teacher data already created. The data processing apparatus 100 according to this exemplary embodiment executed the analysis process to the moving picture data that is the original of new teacher data, by using the created model data.

In a case creating new teacher data on the basis of the moving picture data, the data processing apparatus 100 according to this exemplary embodiment calculates the accuracy rate by comparing the label assigned by the user with the above-mentioned analysis result with respect to the still image included in the moving picture data.

That is, the data processing apparatus 100 according to this exemplary embodiment is able to display, to the user, the information (the accuracy rate) about the accuracy of the data analysis using the machine learning system which has executed learning process by using the teacher data that has already been created.

As a result, the user can refer to the information (the accuracy rate) about the accuracy of the analysis result when the user creates the teacher data, by using the data processing apparatus 100 according to this exemplary embodiment. The user can conduct the operation such like suspending the creation of new teacher data, when a target accuracy is achieved, by referring to the information about the accuracy.

Also, the user can confirm the variation in accuracy of the analysis result, when creating the teacher data, by using the data processing apparatus 100 according to this exemplary embodiment. For example, when in spite of increase in the number of the teacher data, the accuracy is not improved, the user can take a measure such like suspending creation of the teacher data and reexamining the content of the teacher data.

The data processing apparatus 100 according to this exemplary embodiment is able to execute a process similar to the process performed by the data processing apparatus 100 according to the above-mentioned exemplary embodiment. Therefore, the data processing apparatus 100 according to this exemplary embodiment provides an effect similar to that of the data processing apparatus 100 according to the above-mentioned exemplary embodiment.

As described above, the data processing apparatus 100 according to this exemplary embodiment is able to efficiently create the teacher data by extracting the data from the moving picture data on the basis of the specific criteria, providing methods for classifying (labeling) the data. Especially, the data processing apparatus 100 according to this exemplary embodiment is able to provide information by which the user can determine whether or not the amount or the quality of the teacher data are sufficient.

### First Modified Embodiment of Fourth Exemplary Embodiment

Next, a first modified embodiment of the fourth exemplary embodiment will be described. The configuration of the data processing apparatus 100 according to this modified embodiment may be similar to that of the data processing apparatus 100 according to the fourth exemplary embodiment.

In the fourth exemplary embodiment, the data processing apparatus 100 displays the calculated accuracy rate (for example, on the UI screen 110a or the like) to the user.

In contrast, in the data processing apparatus 100 according to this modified embodiment, an target value of the accuracy rate to finish creation of the teacher data is set in advance. For example, the target value may be set to the setting information table 104 in advance.

The data processing apparatus 100 according to this modified embodiment calculates the accuracy rate by executing the process similar to the process described in the fourth exemplary embodiment. When the accuracy rate reaches the target value, the data processing apparatus 100 according to this modified embodiment finishes the creation of the teacher data. The data processing apparatus 100 according to this modified embodiment may notify the user of information that the creation process of the teacher data can be finished.

The data processing apparatus 100 according to this modified embodiment configured as above is able to determine whether or not the creation of the teacher data can be finished, on the basis of the predetermined setting value (the target value of the accuracy rate).

The data processing apparatus 100 according to this modified embodiment is able to execute a process similar to the process performed by the data processing apparatus 100 according to the fourth exemplary embodiment. Therefore, the data processing apparatus 100 according to this modified embodiment is able to provide an effect similar to that of the data processing apparatus 100 according to the fourth exemplary embodiment.

### Second Modified Embodiment of Fourth Exemplary embodiment

Next, the second modified embodiment of the fourth exemplary embodiment will be described. The configuration of the data processing apparatus 100 according to this modified embodiment may be similar to that of the data processing apparatus 100 according to the fourth exemplary embodiment.

In this modified embodiment, the operation of the image analysis unit 106 is partially different from the operation of the image analysis unit 106 according to the fourth exemplary embodiment. The difference will be described below.

The image analysis unit 106 according to the fourth exemplary embodiment described above, executes the learning process of the machine learning system by using the teacher data stored in the teacher data storage unit 107, at the timing at which the amount of the teacher data stored in the teacher data storage unit 107 satisfies the predetermined amount. By this process, the image analysis unit 106 according to the fourth exemplary embodiment creates the model data. The image analysis unit 106 according to the fourth exemplary embodiment analyzes the moving picture data stored in the moving picture data storage unit 105 by using the created model data.

The image analysis unit 106 according to this modified embodiment creates the model data like the fourth exemplary embodiment.

When the image analysis unit 106 according to this modified embodiment is requested to provide the analysis result of the specific still image by the image data extraction unit 101 in step S1103, the image analysis unit 106 calculates the analysis result of the still image.

That is, the image analysis unit 106 according to the fourth exemplary embodiment calculates the analysis result in advance by analyzing the moving picture data stored in the moving picture data storage unit 105 by using the model data created at the predetermined timing. In contrast, the image analysis unit 106 according to this modified embodiment calculates the analysis result of a specific still image, when the image analysis unit 106 according to this modified embodiment is requested to provide the analysis result of the specific still image by the image data extraction unit 101. Therefore, the data processing apparatus 100 according to this modified embodiment is able to reduce a calculation amount required for the calculation of the reliability.

The data processing apparatus 100 according to this modified embodiment has a configuration similar to that of the data processing apparatus 100 according to the fourth exemplary embodiment. Therefore, the data processing apparatus 100 according to this modified embodiment is able to provide an effect similar to that of the data processing apparatus 100 according to the fourth exemplary embodiment.

### Fifth Exemplary embodiment

Next, a fifth exemplary embodiment of the invention of the present application will be described with reference to FIG. 13.

A data processing apparatus 1300 according to this exemplary embodiment includes a data extraction unit 1301, a teacher data creation unit 1302, and a teacher data complement unit 1303. In this exemplary embodiment, the above-mentioned components of the data processing apparatus 1300 are connected to each other by arbitrary known communication methods (a communication bus, a communication network, or the like) so as to be communicable with each other. Each component will be described below.

The data extraction unit (data extracting means) 1301 extracts a teacher-data-candidate that is a part of the data at a specific timing from a time series data. In this exemplary embodiment, for example, the time series data may be the moving picture data. The data extraction unit 1301 may be configured to be similar to the image data extraction unit 101 according to the above mentioned exemplary embodiment.

The teacher data creation unit (teacher data creation means) 1302 creates the teacher data on the basis of a label which can classify the above mentioned teacher-data-candidate and the above mentioned teacher-data-candidate to which the label is assigned. The teacher data creation unit 1302 may be configured to be similar to the teacher data creation unit 1302 according to the above-mentioned exemplary embodiment.

The teacher data complement unit (teacher data complement means) 1303 extracts the new teacher-data-candidate from the time series data which exists between the specific teacher-data-candidate and another teacher-data-candidate, on the basis of a degree of variation between the specific teacher-data-candidate at a specific timing and the one of other teacher-data-candidates at a timing different from the specific timing in time series. The teacher data complement unit 1303 may be configured to be similar to the teacher data complement unit 103 according to the above-mentioned exemplary embodiment.

When the degree of variation is smaller than a first reference (such as the first reference described in above mentioned exemplary embodiments), the teacher data creation unit 1302 assigns the label which is assigned to either the specific teacher-data-candidate or the one of other teacher-data-candidates to the above mentioned teacher-data-candidates extracted by the teacher data complement unit 1303, and appends the labeled teacher-data-candidates to the teacher data.

When the variation between two extracted candidates for the teacher data is smaller than the first reference, the data processing apparatus 1300 according to this exemplary embodiment which has the above-mentioned configuration is able to automatically assign the label to the data which exists between the two candidates for the teacher data in time series.

As a result, even when the number of the candidates for the teacher data to which the label is assigned by the user is small, the data processing apparatus 100 according to this exemplary embodiment is able to automatically create the appropriate number of the teacher data. That is, the data processing apparatus 100 according to this exemplary embodiment is able to reduce workloads required for labeling by the user.

As described above, the data processing apparatus 100 according to this exemplary embodiment can efficiently create the teacher data by extracting the data from the moving picture data that is the time series data on the basis of the specific criteria and providing means for classifying (performing labeling of) the data.

### Configuration of Hardware and Software Program (Computer Program)

Next, the configuration of hardware and software program which can realize each exemplary embodiment described above will be described. In the following explanation, the data processing apparatuses (100 and 1300) may be collectively referred as the “data processing apparatus”.

The data processing apparatus described in the above-mentioned exemplary embodiment may be realized by a dedicated hardware apparatus. In the case, each unit shown in each figure may be realized as hardware (such as an integrated circuit in which a processing logic is incorporated or the like) in which a part of or all of units are integrated.

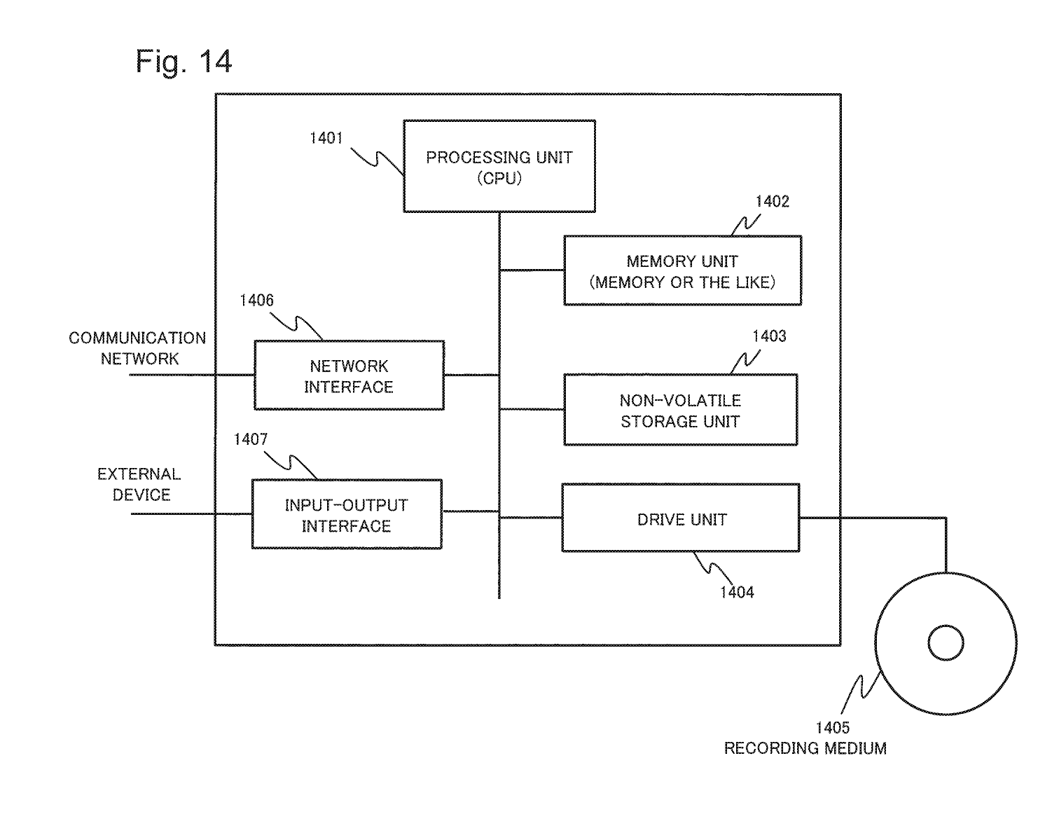

Further, the above-mentioned data processing apparatus may be realized by hardware exemplary illustrated in FIG. 14 and various software programs (computer programs) executed by the hardware.

An processing unit 1401 shown in FIG. 14 is an processing device such as a general-purpose CPU (Central Processing Unit), a microprocessor, or the like. For example, the processing unit 1401 may load various software programs stored in a non-volatile storage unit 1403, to a memory unit 1402, and execute a process according to the loaded software program.

The memory unit 1402 is a memory device such as a RAM (Random Access Memory) or the like, which can be referred to by the processing unit 1401, and stores the software program, the various data, or the like. The memory unit 1402 may be implemented by a volatile memory unit.

The non-volatile storage unit 1403 may be a non-volatile storage device, for example, such as a ROM (Read Only Memory) implemented by semiconductor storage device, a flash memory, a magnetic disk drive, or the like, and may record the various software programs, the data, and the like.

For example, the moving picture data storage unit 105, the teacher data storage unit 107, the model data storage unit 108, and the analysis result storage unit 109 in the data processing apparatus may use a file, a database, and the like, stored in the non-volatile storage unit 1403.

For example, a drive unit 1404 is an device which executes a process for reading data from a recording medium 1405, and writing data to the recording medium 1405.

The recording medium 1405 is an arbitrary non-transitory recording medium such as an optical disc, a magneto-optical disc, a semiconductor flash memory, or the like which can record the data.

A network interface 1406 is an interface device which connects the data processing apparatus and the arbitrary communication network including a wired network, a wireless network, or a combination of these networks, so as to be communicable with each other. For example, the data processing apparatus according to this exemplary embodiment may be connected to the communication network via the network interface 1406.

An input-output interface 1407 is an interface to which an input device that supplies various inputs to the data processing apparatus, and an output device that receives various outputs from the data processing apparatus, are connected.

For example, the display unit 110 in the data processing apparatus may displays the UI screen 110a on a display apparatus (not shown) connected via the input-output interface 1407. Further, the user may supply the label or the like to the data processing apparatus by using the input device (such as a keyboard, a mouse, or the like) connected via the input-output interface 1407.

For example, the present invention which has been described above by using each exemplary embodiment as an example, may be realized, for example, by implementing the data processing apparatus by using the hardware device shown in FIG. 14, and supplying a software program that functions described in each exemplary embodiment is implemented, to the data processing apparatus. In this case, the processing unit 1401 executes the software program supplied to the data processing apparatus and whereby, the invention of the present application may be achieved.

In each exemplary embodiment mentioned above, each unit shown in each figure can be realized as a software module that is a functional unit of the software program executed by the above-mentioned hardware. However division of these software modules illustrated in the figure is only for convenience of explanation. As to implementation of the software program, various configuration of software modules may be considered.

For example, when each component of the data processing apparatus illustrated in FIG. 1, FIG. 5, FIG. 7, FIG. 10, and FIG. 13 is realized as the software module, the software modules may be stored in the non-volatile storage unit 1403, and the processing unit 1401 may be configured to load these software modules to the memory unit 1402, when executing each process with regard to each software module.

These software modules may be configured to transmit and receive various data with each other, by using a suitable method such as a shared memory, inter-process communication, or the like. By this, these software modules can be connected to each other so as to be communicable with each other.

Moreover, for example, these software programs may be recorded in the recording medium 1405, and may be stored into the non-volatile storage unit 1403, in a shipping phase of the data processing apparatus, an operation phase, or the like, via the drive unit 1404.

In the above-mentioned case, for example, as a method for supplying these software programs to the data processing apparatus, a method to install these software programs in the data processing apparatus by using appropriate jigs may be used, in a manufacturing phase before shipment, a maintenance phase after shipment, or the like. As a method for supplying the these software programs to the data processing apparatus, a currently known method may be used, such as a method for downloading these software programs via a communication line such as the Internet or the like.

In such case, for example, the present invention can be considered to be realized by a code which implements the software program, or a computer-readable storage medium recorded with (storing) the code.

Additionally, the following situation exists with respect to the present invention described by using the above-mentioned exemplary embodiment. That is, as described above, there is a problem that the data analysis using the machine learning system needs man-hours and workloads for preparing the teacher data. In particular, the preparation of the teacher data required for the analysis of the moving picture data is executed by using a method which depends on human vision, on the basis of a large amount of still images constituting the moving picture. For this reason, in order to obtain the sufficient amount of the teacher data, many man-hours are needed.

The technology disclosed in patent literature 1 assumes that a detection process and a clustering process that are having a practical detection performance are available. When the detection process and the clustering process are unavailable, the appropriate learning image may not be obtained by the technology disclosed in patent literature 1.

The technology disclosed in patent literature 2 is a technology for obtaining the learning data used for the re-learning of the classifier,. by using the classifier having practical performance. In the technology disclosed in patent literature 2, the learning data (the teacher data) has to be separately prepared in order to realize the classifier having the practical performance, and it may take many man-hours to prepare the teacher data.

The technology disclosed in patent literature 3 assigns a plurality of classes additionally to the basic data, to which classes are assigned by the user. That is, the user has to assign the class to the basic data. Therefore, when a large number of the basic data exist, it may take many man-hours to assign the class to the basic data, by the technology disclosed in patent literature 3.

The patent literature 4 only discloses a technology for adjusting the extraction interval of the still image according to speed of a motion of a target object included (recorded) in the moving picture. That is, the technology disclosed in patent literature 4 is one specific technique for extracting the still image from the moving picture. The technology disclosed in patent literature 4 cannot be directly applied to the creation of the teacher data used for machine learning.

The present invention is made in view of the above mentioned situation.

That is, by the present invention, the data processing apparatus, which is able to efficiently create the teacher data by extracting data that is a base of the teacher data from the time series data on the basis of a specific criteria, and classifying the extracted data or the like, is provided.

The present invention can be applied, for example, to a case in which the teacher data is created from the moving picture data, with respect to an apparatus for analyzing the moving picture data by using the machine learning system. Specifically, for example, the present invention can be applied to an image analysis apparatus which detects the image data that satisfies a specific condition from a large number of image data recorded by a security camera, or image analysis apparatus which notifies a warning when a specific event is detected in the image data recorded by the security camera, or the like.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

Part or all of the exemplary embodiments and the modifications thereof may be described as the following Supplemental Notes. The present invention exemplarily described by the embodiments and the modifications thereof, however, is not limited to the following.

(Supplemental Notes 1)

A data processing apparatus including:

a data extraction unit that is configured to extract a candidate of teacher data that is a part of data at a specific timing, from time series data;

a teacher data creation unit that is configured to create teacher data on the basis of a label by which the candidate of teacher can be classified and the candidate of teacher data to which the label is assigned; and

a teacher data complement unit that is configured to further extract the candidate of the teacher data from the time series data that exists between a specific candidate of the teacher data and one of other candidates of the teacher data on the basis of a degree of a variation between the specific candidate of the teacher data at a specific timing, and the one of other candidates of the teacher data at a timing different from the specific timing, in time series data,

the candidate of the teacher data extracted by the teacher data complement unit being assigned with the label that is assigned to either the specific candidate of the teacher data or the one of other candidates of the teacher data and being appended to the teacher data, by the teacher data creation unit, when the degree of the variation is smaller than a first reference.

(Supplemental Notes 2)

The data processing apparatus according to Supplemental Notes 1,

wherein the data extraction unit extracts the candidate of the teacher data from the time series data at a specific time interval that is set to the data processing apparatus.

(Supplemental Notes 3)

The data processing apparatus according to Supplemental Notes 2,

wherein the data extraction unit further extracts a specific number of the candidates of the teacher data, from the time series data which exists between a first candidate of the teacher data and a second candidate of the teacher data, when a variation between the first candidate of the teacher data and the second candidate of the teacher data exceeds a second reference, the first candidate of the teacher data being data at a specific timing in the time series data, and the second candidate of the teacher data being data at a timing different from the specific timing by the predetermined time interval.

(Supplemental Notes 4)

The data processing apparatus according to any one of Supplemental Notes 1 to Supplemental Notes 3, further including:

a background image extraction unit that is configured to extract an image whose degree of a variation of a content recorded in time series data in a specific period is smaller than a background image variation reference as an background image, when the time series data is the moving picture data,

wherein the data extraction unit determines whether or not to extract the image data as the candidate of the teacher data, on the basis of the degree of the difference between a image data extracted from the moving picture data at a certain timing and the background image.

(Supplemental Notes 5)

The data processing apparatus according to any one of Supplemental Notes 1 to Supplemental Notes 4, further including:

a model data storage unit that if configured to store model data that is a result obtained by executing a learning process in a machine learning system by using the teacher data; and

a time series data analysis unit that is configured to determine the label assigned to the data included in the time series data by analyzing the time series data by using the model data, and to calculate reliability indicating the degree of certainty with regard to the determination,

wherein the teacher data creation unit excludes the candidate of the teacher data, from the creation of the teacher data, when the reliability calculated to the candidate of the teacher data extracted among the time series data is higher than a predetermined reliability reference.

(Supplemental Notes 6)

The data processing apparatus according to Supplemental Notes 5, further including:

a teacher data storage unit that is configured to store the teacher data,

wherein the time series data analysis unit executes operation for creating the model data by executing the learning process in the machine learning system by using the stored teacher data, and executes operation for storing the created model data in the model data storage unit, when a predetermined amount or more of the teacher data is stored in the teacher data storage unit.

(Supplemental Notes 7)

The data processing apparatus according to any one of Supplemental Notes 1 to Supplemental Notes 6,

wherein the teacher data creation unit displays the candidate of the teacher data to a user,

receives the label assigned to the presented candidate of the teacher data by the user, and

creates the teacher data on the basis of the received label and the candidate of the teacher data to which the label is to be assigned.

(Supplemental Notes 8)

The data processing apparatus according to Supplemental Notes 6,

wherein the teacher data creation unit displays the candidate of the teacher data to the user,

receives the label assigned to the displayed candidate of the teacher data by the user,

calculates an accuracy rate of the label assigned to the data extracted as the candidate of the teacher data among the time series data by the time series data analysis unit, on the basis of a result of comparison between the label assigned to the candidate of the teacher data by the time series data analysis unit, and the label assigned to the candidate of the teacher data by the user, and

provides user interface to display the calculated accuracy rate.

(Supplemental Notes 9)

A data processing method including:

extracting a candidate of teacher data from time series data that exists between a specific candidate of the teacher data and one of other candidates of the teacher data on the basis of a degree of variation between the specific candidate of the teacher data and the one of other candidates of the teacher data, the specific candidate of the teacher data being a part of data at a specific timing in the time series data, and the one of other candidates of the teacher data being a part of data at a timing different from the specific timing in the time series data,

assigning a label, by which the candidate of the teacher data can be classified, to the extracted candidate of the teacher data, when the degree of variation is smaller than a first reference, the label assigned to the extracted candidate of the teacher data being the label assigned to either the specific candidate of the teacher data or the one of other candidates of the teacher data, and

creating the teacher data on the basis of the data to which the label is assigned.

(Supplemental Notes 10)

A non-transitory computer readable recording medium storing a computer program which allows a computer to execute:

a process to extract a candidate of teacher data from time series data that exists between a specific candidate of the teacher data and one of other candidates of the teacher data, on the basis of a degree of variation between the specific candidate of the teacher data and the one of other candidates of the teacher data, the specific candidate of the teacher data being a part of data at a specific timing in the time series data, and the one of other candidates of the teacher data being a part of data at a timing different from the specific timing in the time series data,

a process to assign a label, by which the candidate of the teacher data can be classified, to the extracted candidate of the teacher data, when the degree of variation is smaller than a first reference, the label assigned to the extracted candidate of the teacher data being the label assigned to either the specific candidate of the teacher data or the one of other candidates of the teacher data, and

a process to create the teacher data on the basis of the data to which the label is assigned.

(Supplemental Notes 11)

A data processing method including:

displaying a first candidate of teacher data that is a part of data at a specific timing in time series data, and a second candidate of teacher data that is a part of data at a timing different from the specific timing in the time series data and whose degree of variation from the first candidate of the teacher data exceeds a specific reference, and

creating the teacher data on the basis of at least one of the candidates of the teacher data displayed to the user and a label, by which the candidate of the teacher data can be classified, assigned to the candidate of the teacher data by the user.

(Supplemental Notes 12)

A data processing method including:

displaying a first candidate of teacher data that is a part of data at a specific timing in time series data and a second candidate of teacher data that is a part of data at a timing different from the specific timing included in the time series data,

displaying one or more data which exist between the first candidate of the teacher data and the second candidate of the teacher data in the time series data to the user as the candidate of the teacher data, when a degree of variation between the first candidate of the teacher data and the second candidate of the teacher data exceeds a specific reference, and

creates the teacher data on the basis of at least one of the candidates for the teacher data displayed to the user and a label, by which the candidate of the teacher data can be classified, assigned to the candidate of the teacher data by the user.

(Supplemental Notes 13)

The data processing method according to Supplemental Notes 11,

wherein the second candidate of the teacher data is a part of the time series data at a timing different from the specific timing by a predetermined time interval.

(Supplemental Notes 14)

A data processing apparatus including:

a user interface display unit that is configured to display a first candidate of teacher data that is a part of data at a specific timing included in time series data and a second candidate of teacher data that is a part of data at a timing different from the specific timing included in the time series data and

to display one or more data which exist between the first candidate of the teacher data and the second candidate of the teacher data in the time series data to the user as the candidate of the teacher data, when a degree of variation between the first candidate of the teacher data and the second candidate of the teacher data exceeds a specific reference and

a teacher data creation unit that is configured to create the teacher data on the basis of at least one of the candidates for the teacher data displayed to the user and a label, by which the candidate of the teacher data can be classified, assigned to the candidate of the teacher data by the user.

What is claimed is:

1. A data processing apparatus comprising:
a data extraction unit that is configured to extract a candidate of teacher data that is a part of data at a specific timing, from time series data;
a teacher data creation unit that is configured to create teacher data on the basis of a label by which the candidate of teacher can be classified and the candidate of teacher data to which the label is assigned; and
a teacher data complement unit that is configured to further extract the candidate of the teacher data from the time series data that exists between a specific candidate of the teacher data and one of other candidates of the teacher data on the basis of a degree of a variation between the specific candidate of the teacher data at a specific timing, and the one of other candidates of the teacher data at a timing different from the specific timing, in time series data,
the candidate of the teacher data extracted by the teacher data complement unit being assigned with the label that is assigned to either the specific candidate of the teacher data or the one of other candidates of the teacher data and being appended to the teacher data, by the teacher data creation unit, when the degree of the variation is smaller than a first reference.

2. The data processing apparatus according to claim 1,
wherein the data extraction unit extracts the candidate of the teacher data from the time series data at a specific time interval that is set to the data processing apparatus.

3. The data processing apparatus according to claim 2,
wherein the data extraction unit further extracts a specific number of the candidates of the teacher data, from the time series data which exists between a first candidate of the teacher data and a second candidate of the teacher data, when a variation between the first candidate of the teacher data and the second candidate of the teacher data exceeds a second reference, the first candidate of the teacher data being data at a specific timing in the time series data, and the second candidate of the teacher data being data at a timing different from the specific timing by the predetermined time interval.

4. The data processing apparatus according to claim 1, further comprising:
a background image extraction unit that is configured to extract an image whose degree of a variation of a content recorded in time series data in a specific period is smaller than a background image variation reference as an background image, when the time series data is the moving picture data,
wherein the data extraction unit determines whether or not to extract the image data as the candidate of the teacher data, on the basis of the degree of the difference between a image data extracted from the moving picture data at a certain timing and the background image.

5. The data processing apparatus according to claim 1, further comprising:
a model data storage unit that if configured to store model data that is a result obtained by executing a learning process in a machine learning system by using the teacher data; and
a time series data analysis unit that is configured to determine the label assigned to the data included in the time series data by analyzing the time series data by using the model data, and to calculate reliability indicating the degree of certainty with regard to the determination,
wherein the teacher data creation unit excludes the candidate of the teacher data, from the creation of the teacher data, when the reliability calculated to the candidate of the teacher data extracted among the time series data is higher than a predetermined reliability reference.

6. The data processing apparatus according to claim 5, further comprising:
a teacher data storage unit that is configured to store the teacher data,
wherein the time series data analysis unit executes operation for creating the model data by executing the learning process in the machine learning system by using the stored teacher data, and executes operation for storing the created model data in the model data storage unit, when a predetermined amount or more of the teacher data is stored in the teacher data storage unit.

7. The data processing apparatus according to claim 1,
wherein the teacher data creation unit displays the candidate of the teacher data to a user,
receives the label assigned to the presented candidate of the teacher data by the user, and
creates the teacher data on the basis of the received label and the candidate of the teacher data to which the label is to be assigned.

8. The data processing apparatus according to claim 6,
wherein the teacher data creation unit displays the candidate of the teacher data to the user,
receives the label assigned to the displayed candidate of the teacher data by the user,
calculates an accuracy rate of the label assigned to the data extracted as the candidate of the teacher data among the time series data by the time series data analysis unit, on the basis of a result of comparison between the label assigned to the candidate of the teacher data by the time series data analysis unit, and the label assigned to the candidate of the teacher data by the user, and
provides user interface to display the calculated accuracy rate.

9. A data processing method comprising:
extracting a candidate of teacher data from time series data that exists between a specific candidate of the teacher data and one of other candidates of the teacher data on the basis of a degree of variation between the specific candidate of the teacher data and the one of other candidates of the teacher data, the specific candidate of the teacher data being a part of data at a specific timing in the time series data, and the one of other candidates of the teacher data being a part of data at a timing different from the specific timing in the time series data,
assigning a label, by which the candidate of the teacher data can be classified, to the extracted candidate of the teacher data, when the degree of variation is smaller than a first reference, the label assigned to the extracted candidate of the teacher data being the label assigned to either the specific candidate of the teacher data or the one of other candidates of the teacher data, and
creating the teacher data on the basis of the data to which the label is assigned.

10. A data processing method comprising:
displaying a first candidate of teacher data that is a part of data at a specific timing in time series data, and a second candidate of teacher data that is a part of data at a timing different from the specific timing in the time series data and whose degree of variation from the first candidate of the teacher data exceeds a specific reference, and
creating the teacher data on the basis of at least one of the candidates of the teacher data displayed to the user and a label, by which the candidate of the teacher data can be classified, assigned to the candidate of the teacher data by the user.

11. The data processing method according to claim 11,
wherein the second candidate of the teacher data is a part of the time series data at a timing different from the specific timing by a predetermined time interval.
